(19) United States
(12) Patent Application Publication
(10) Pub. No.: US 2025/0031161 A1
(43) Pub. Date: Jan. 23, 2025

(54) SSB-SUBSET SELECTION BASED RACH WITH BASE STATION-SIDE BEAM PREDICTION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US); Jelena DAMNJANOVIC, Del Mar, CA (US)

(21) Appl. No.: 18/711,563

(22) PCT Filed: Jan. 17, 2022
(86) PCT No.: PCT/CN2022/072333

§ 371 Date: May 17, 2024

(51) Int. Cl. H04W 56/00; H04B 7/06; H04L 5/00; H04W 74/0833

(52) U.S. Cl. CPC H04W 56/0015; H04B 7/06952; H04L 5/0048; H04W 74/0833

(57) ABSTRACT

Apparatus, methods, and computer-readable media for facilitating SSB-subset selection based RACH with base station-side beam prediction are disclosed herein. An example method for wireless communication at a user equipment (UE) includes measuring one or more synchronization signal block (SSB) subsets of an SSB burst set including multiple SSBs grouped into SSB subsets. The example method also includes transmitting, to a base station, a random access message indicating information for at least one SSB subset from the one or more SSB subsets and measurement information for one or more SSBs of the at least one SSB subset.

### CROSS REFERENCE TO RELATED APPLICATION(S)

This application is a National Stage Application filed under 35 U.S.C. § 371 of PCT International Application No. PCT/CN2022/072333, entitled “SSB-SUBSET SELECTION BASED RACH WITH BASE STATION-SIDE BEAM PREDICTION” and filed Jan. 17, 2022, which is expressly incorporated by reference herein in its entirety.

### TECHNICAL FIELD

The present disclosure relates generally to communication systems, and more particularly, to wireless communication utilizing beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). An example apparatus may measure one or more synchronization signal block (SSB) subsets of an SSB burst set including multiple SSBs grouped into SSB subsets. Additionally, the example apparatus may transmit, to a base station, a random access message indicating information for at least one SSB subset from the one or more SSB subsets and measurement information for one or more SSBs of the at least one SSB subset.

In another aspect of the disclosure, a method, a computer-readable medium, and an apparatus are provided for wireless communication at a network node. An example apparatus may transmit an SSB burst set including multiple SSBs grouped into one or more SSB subsets. Additionally, the example apparatus may receive a random access message indicating information for at least one SSB subset from the one or more SSB subsets and measurement information for one or more SSBs of the at least one SSB subset.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and a UE in an access network.

FIG. 4A illustrates an example flow diagram of a beam management procedure for a base station and a UE, in accordance with various aspects of the present disclosure.

FIG. 4B illustrates an example of SSB beam sweeping between the base station and the UE, in accordance with various aspects of the present disclosure.

FIG. 4C illustrates an example of beam refinement between the base station and the UE, in accordance with various aspects of the present disclosure.

FIG. 5A illustrates an example of beam pair link (BPL) discovery and refinement, in accordance with various aspects of the present disclosure.

FIG. 5B illustrates another example of BPL discovery and refinement, in accordance with various aspects of the present disclosure.

FIG. 5C illustrates another example of BPL discovery and refinement, in accordance with various aspects of the present disclosure.

FIG. 6A is a diagram illustrating a communication flow between a base station and a UE implementing a four-step RACH procedure, in accordance with various aspects of the present disclosure.

FIG. 6B is a diagram illustrating a communication flow between the base station and the UE implementing a two-step RACH procedure, in accordance with various aspects of the present disclosure.

FIG. 7 illustrates an example communication flow between a base station and a UE, in accordance with various aspects of the present disclosure.

FIG. 8 illustrates an example communication flow between a base station and a UE, in accordance with various aspects of the present disclosure.

FIG. 9 illustrates an example communication flow between a base station and a UE, in accordance with various aspects of the present disclosure.

FIG. 10 illustrates example grouping options of SSB subsets that may be indicated via configuration information, in accordance with various aspects of the present disclosure.

FIG. 11 is a flowchart of a method of wireless communication at a UE, in accordance with the teachings disclosed herein.

FIG. 12 is a flowchart of a method of wireless communication at a UE, in accordance with the teachings disclosed herein.

FIG. 13 is a diagram illustrating an example of a hardware implementation for an example apparatus, in accordance with the teachings disclosed herein.

FIG. 14 is a flowchart of a method of wireless communication at a base station, in accordance with the teachings disclosed herein.

FIG. 15 is a flowchart of a method of wireless communication at a base station, in accordance with the teachings disclosed herein.

FIG. 16 is a diagram illustrating an example of a hardware implementation for an example apparatus, in accordance with the teachings disclosed herein.

### DETAILED DESCRIPTION

Aspects disclosed herein facilitate providing a pre-grouping of SSBs from a base station. A UE may obtain the pre-grouping and report a group index for a subset of SSBs to the base station. The reported group index may be based on measurements performed on the SSBs of the subset of SSBs. In some examples, the UE may also report a beam strength ordering for the SSBs of the subset of SSBs and/or measurement information for the respective SSBs in the subset of SSBs. By reporting a group index for a subset of SSBs, the UE may reduce the overhead associated with transmitting multiple SSB reports indicating the multiple beams as the multiple respective indices and/or measurement information may be indicated via a group index instead of each being individually reported. The UE may transmit the group index via a message of a random access channel (RACH) procedure (e.g., the msg1 of a four-step RACH procedure or the msgA of a two-step RACH procedure).

In some examples, the UE may perform SSB-subset selection-based RACH with base station-side beam prediction. For example, the UE may reduce overhead when reporting SSB indices and related measurement information by providing a group index that corresponds to one or more SSB subsets of an SSB burst set. In some examples, the UE may additionally or alternatively report an ordering of the SSBs within a reported SSB subset. The ordering may be based on measurement information, such as RSRP (e.g., layer 1 RSRP) associated with each beam and/or a signal to interference and noise ratio (SINR) associated with each beam. For example, the UE may order the SSBs within the reported SSB subset based on RSRP measurements of the respective SSBs. The UE may measure SINR to improve performance when performing a beam failure recovery procedure. In some examples, the ordering may be based on reporting the one or more strongest SSB indices. In some examples, the ordering may be based on an explicit ordering report.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and use cases are described in this application by illustration to some examples, additional or different aspects, implementations, and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc., may range a spectrum from chip-level or modular components to non-modular, non-chip-level implementations and further to aggregate, distributed, or original equipment manufacturer (OEM) devices or systems incorporating one or more techniques described herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). The techniques described herein may be practiced in a wide variety of devices, chip-level components, systems, distributed arrangements, aggregated or disaggregated components, end-user devices, etc. of varying sizes, shapes, and constitution.

As described herein, a node, which may be referred to as a node, a network node, or a wireless node, may be a base station, a UE, a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first network node, the second network node, and the third network node may be different relative to these examples. Similarly, reference to a UE, a base station, an apparatus, a device, a computing system, or the like may include disclosure of the UE, the base station, the apparatus, the device, the computing system, or the like being a network node. For example, disclosure that a UE is configured to receive information from a base station also discloses that a first network node is configured to receive information from a second network node. In this example, consistent with this disclosure, the first network node may refer to a first UE, a first base station, a first apparatus, a first device, a first computing system, a first one or more components, a first processing entity, or the like configured to receive the information, and the second network node may refer to a second UE, a second base station, a second apparatus, a second device, a second computing system, a first one or more components, a first processing entity, or the like.

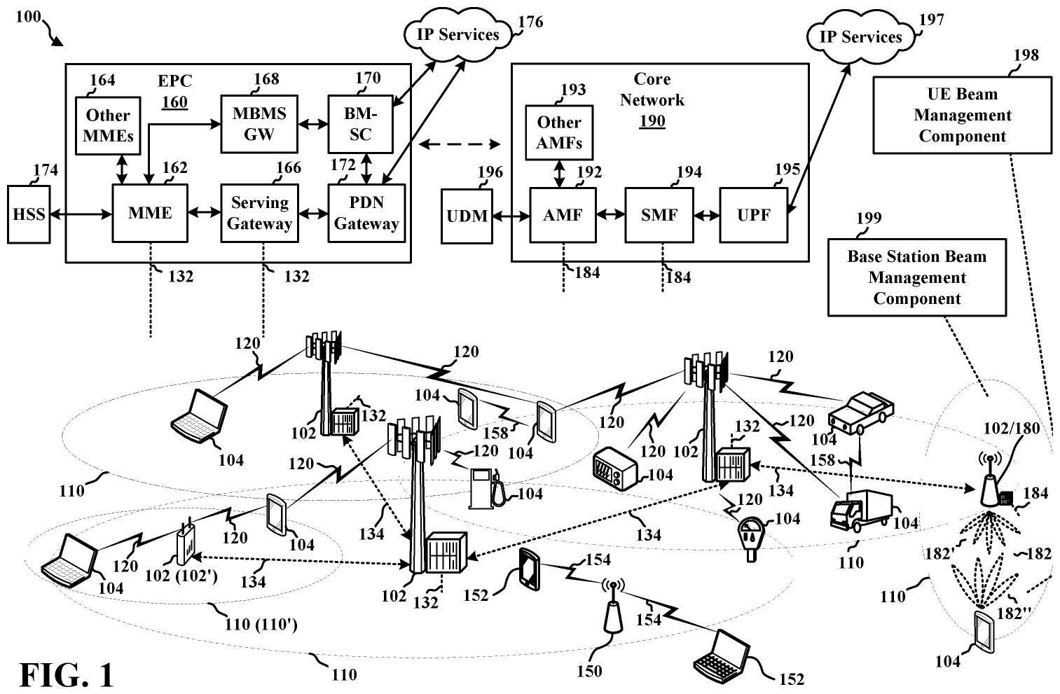

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, a device in communication with a base station, such as the UE 104, may be configured to manage one or more aspects of wireless communication. For example, the UE 104 may include a UE beam management component 198 configured to facilitate SSB-subset selection-based RACH. In some aspects, the UE beam management component 198 may be configured to measure one or more synchronization signal block (SSB) subsets of an SSB burst set including multiple SSBs grouped into SSB subsets. Additionally, the UE beam management component 198 may be configured to transmit, to a base station, a random access message indicating information for at least one SSB subset from the one or more SSB subsets and measurement information for one or more SSBs of the at least one SSB subset.

In another configuration, a network node, such as the base stations 102 and 180, may be configured to manage or more aspects of wireless communication. For example, the base stations 102/180 may include a base station beam management component 199 configured to facilitate SSB-subset selection-based RACH. In some aspects, the base station beam management component 199 may be configured to transmit an SSB burst set including multiple SSBs grouped into one or more SSB subsets. The base station beam management component 199 may also be configured to receive a random access message indicating information for at least one SSB subset from the one or more SSB subsets and measurement information for one or more SSBs of the at least one SSB subset.

The aspects presented herein may enable a UE to provide reporting including multiple SSB indices and associated measurements via group-based SSB subsets, which may facilitate improving communication performance, for example, by reducing reporting overhead. For example, reducing the reporting overhead may reduce latency in communications with a base station.

Although the following description provides examples directed to 5G NR (and, in particular, to beam management), the concepts described herein may be applicable to other similar areas, such as LTE, LTE-A, CDMA, GSM, and/or other wireless technologies, in which a UE may perform a RACH procedure.

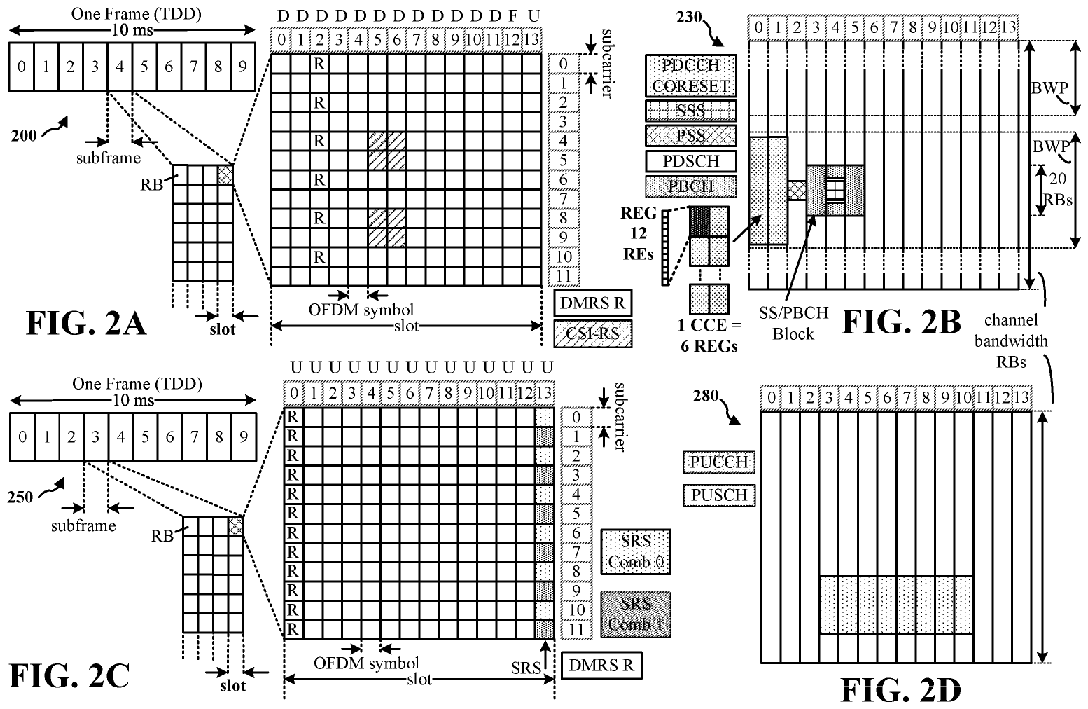

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

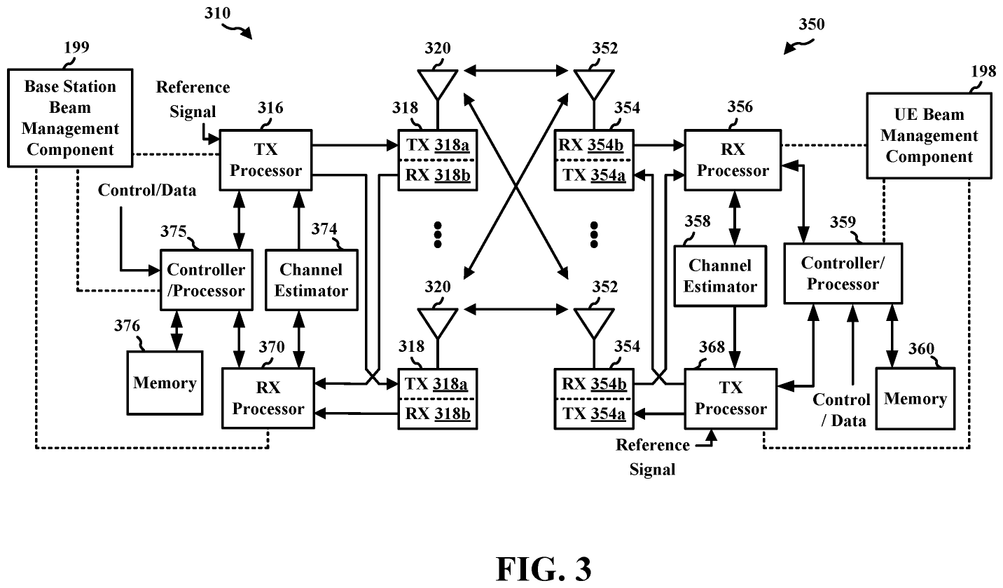

FIG. 3 is a block diagram that illustrates an example of a first wireless device that is configured to exchange wireless communication with a second wireless device. In the illustrated example, the first wireless may include a base station 310, the second wireless device may include a UE 350, and the base station 310 may be in communication with the UE 350 in an access network. As shown in FIG. 3, the base station 310 includes a transmit processor (TX processor 316), a transceiver 318 including a transmitter 318a and a receiver 318b, antennas 320, a receive processor (RX processor 370), a channel estimator 374, a controller/processor 375, and memory 376. The example UE 350 includes antennas 352, a transceiver 354 including a transmitter 354a and a receiver 354b, an RX processor 356, a channel estimator 358, a controller/processor 359, memory 360, and a TX processor 368. In other examples, the base station 310 and/or the UE 350 may include additional or alternative components.

In the DL, IP packets from the EPC 160 may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318a. Each transmitter 318a may modulate a radio frequency (RF) carrier with a respective spatial stream for transmission.

At the UE 350, each receiver 354b receives a signal through its respective antenna 352. Each receiver 354b recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354a. Each transmitter 354a may modulate an RF carrier with a respective spatial stream for transmission.

The UL transmission is processed at the base station 310 in a manner similar to that described in connection with the receiver function at the UE 350. Each receiver 318b receives a signal through its respective antenna 320. Each receiver 318b recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE beam management component 198 of FIG. 1.

At least one of the TX processor 316, the RX processor 370, and the controller/processor 375 may be configured to perform aspects in connection with the base station beam management component 199 of FIG. 1.

A UE trying to access a communication network may follow a cell search procedure that may include a series of synchronization stages. In some examples, the synchronization stages may enable the UE to determine time and/or frequency resources that may be useful for demodulating downlink signals, transmitting with the correct timing, and/or acquiring system information. Synchronization signal blocks (SSBs) may include a primary synchronization signal (PSS), a secondary synchronization signal (SSS), and a physical broadcast channel (PBCH). The UE may use the PSS to determine symbol timing and a physical layer identity. The UE may use the SSS to determine a physical layer cell identity group number (e.g., a “cell identifier”) and radio frame timing. The PBCH may carry a master information block (MIB), which may provide a number of resource blocks in the system bandwidth and a system frame number.

The SSBs may be transmitted (e.g., by a base station) at predetermined locations (e.g., time locations) within an SSB period, and the maximum number of SSBs may depend on the frequency band. In some examples, each SSB may be transmitted on a different beam, and the UE may search for all of the SSBs until the UE identifies a suitable SSB (e.g., an SSB associated with a satisfactory measurement). In some such examples, once the UE identifies a suitable SSB, the UE may read the PBCH and then acquire the SIB (e.g., SIB1), which may indicate how many SSBs are transmitted. For example, as mentioned above, the SSB may include a PSS, an SSS, and PBCH. The UE may obtain symbol timing from the PSS. The UE may then obtain the cell identifier from the SSS. The UE may then read the MIB that is encoded in the PBCH, which may include information used to read SIBs. The UE may then acquire the SIB1. After the UE is operating in a connected mode, the base station may indicate which SSBs are transmitted via a separate dedicated RRC configuration, which may be more detailed than (and may, thus, override) the indication in SIB1.

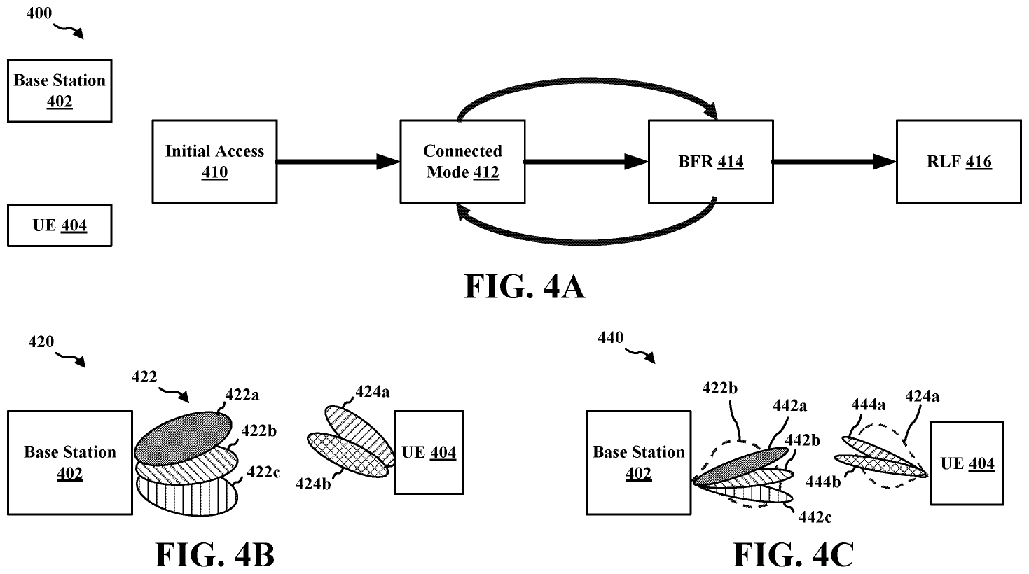

In some examples, to perform beam management procedures, a UE may measure SSBs to facilitate performing a random access channel (RACH) procedure with a base station. FIG. 4A illustrates an example flow diagram 400 of a beam management procedure for a base station 402 and a UE 404, as presented herein. In the illustrated example of FIG. 4A, the UE 404 may perform an initial access procedure 410 to establish a connected mode state 412 with a communication network (e.g., the base station 402). For example, the initial access procedure 410 may include the base station 402 performing SSB beam sweeping in which the base station 402 may transmit SSBs in different directions and/or angles to facilitate analog beam forming. As used herein, the terms “SSB” may be used to identify a “beam” on which the SSB is transmitted, except when indicated. The UE 404 may receive one or more SSBs, perform measurements on the received SSBs, and select a strongest SSB, or a beam on which a strongest SSB is received, based on the measurements of the received SSB. The SSBs may be associated with wide beams (e.g., layer 1 (L1) beams). The UE 404 may then perform the RACH procedure with the base station 402 using a beam based on the selected SSB. For example, the UE 404 may transmit a preamble corresponding to the selected SSB.

FIG. 4B illustrates an example of SSB beam sweeping 420 between the base station 402 and the UE 404, as presented herein. In the example of FIG. 4B, the base station 402 transmits an SSB burst set 422 including a first beam 422a, a second beam 422b, and a third beam 422c. The UE 404 may perform measurements on the received beams and indicate a strongest beam. As shown in FIG. 4B, the UE 404 receives a first beam 424a and a second beam 424b. In some examples, based on the indicated strongest beam, the base station 402 and the UE 404 may establish a beam pair link. For example, to facilitate downlink communication from the base station 402 to the UE 404, the base station 402 may transmit the downlink communication using the second beam 422b and the UE 404 may receive the downlink communication using the first beam 424a. In such examples, the selected beam pair (e.g., the second beam 422b and the first beam 424a) may be referred to as a beam pair link.

However, in such scenarios, the UE 404 may perform measurements on multiple SSBs before selecting the strongest beam, which may also increase latency as the quantity of SSBs may be large. To improve performance of the beam management procedure, in some examples, the UE 404 may be configured to measure a reduced quantity of SSBs (e.g., a subset of the SSBs). For example, the base station 402 may transmit sixteen beams, but the UE 404 may measure four of the beams.

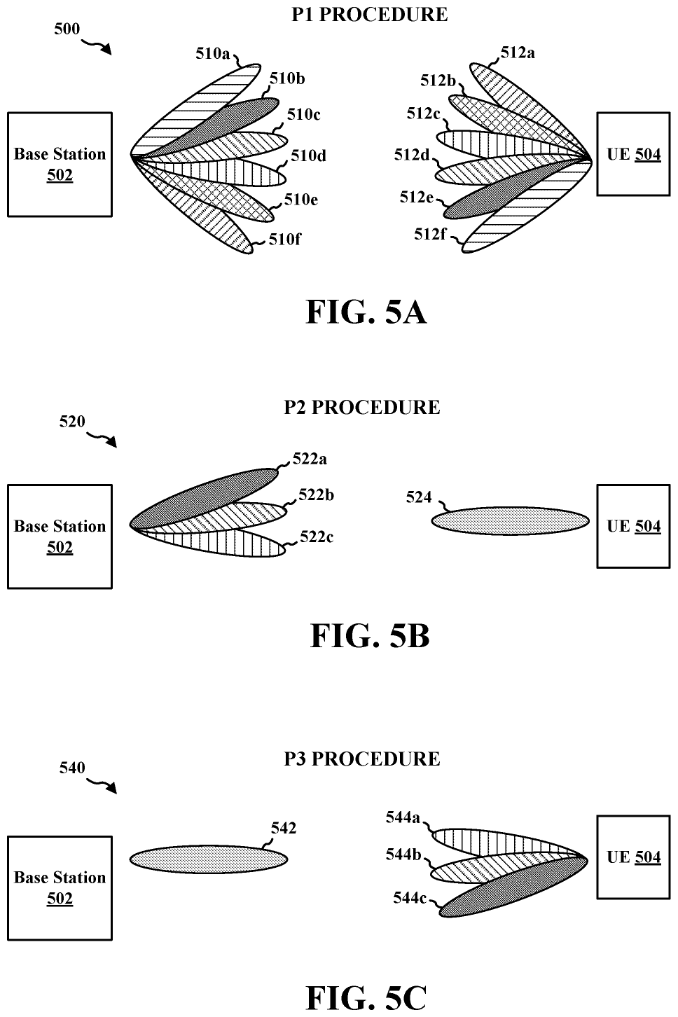

After the initial access procedure 410 is complete, the UE 404 may operate in the connected mode state 412. While operating in the connected mode state 412, the base station 402 and the UE 404 may perform beam refinement procedures. In some examples, such procedures may be referred to as “sunny day operations.” In some examples, the beam refinement procedures may include hierarchical beam refinement (e.g., P1, P2, P3 procedures, as described in connection with examples of FIGS. 5A, 5B, and 5C). In some examples, the beam refinement procedures may include U1, U2, U3 procedures. The base station 402 and the UE 404 may transmit layer 1 reports to facilitate the beam refinement.

FIG. 4C illustrates an example of beam refinement 440 between the base station 402 and the UE 404, as presented herein. In the example of FIG. 4C, the base station 402 and the UE 404 perform a CSI-RS beam sweep. For example, the base station 402 may transmit a first CSI-RS 442a, a second CSI-RS 442b, and a third CSI-RS 442c. As shown in FIG. 4C, the first CSI-RS 442a, the second CSI-RS 442b, and the third CSI-RS 442c are narrower beams within the second beam 422b selected at the base station 402 for the beam pair link. The UE 404 may perform measurements on CSI-RS received at narrower beams within the first beam 424a selected at the UE 404 for the beam pair link. For example, the UE 404 may perform measurements on a first beam 444a and a second beam 444b that are narrower beams than the first beam 424a. The base station 402 and the UE 404 may then select another beam pair link based on the narrower beams. It may be appreciated that the base station 402 and the UE 404 may communicate using the wider beams, as shown in FIG. 4B, and/or using the narrower beams, as shown in FIG. 4C.

Returning to the flow diagram of FIG. 4A, while operating in the connected mode state 412, the base station 402 and the UE 404 may experience a beam failure. For example, a selected beam of the beam pair link may become blocked. In such examples, the base station 402 and the UE 404 may perform a beam failure recovery (BFR) procedure. For example, the base station 402 and the UE 404 may perform a BFR procedure 414 to facilitate a fast recovery.

In some examples, when the BFR procedure 414 is successful, the UE 404 returns to operating in the connected mode state 412. However, in some examples, the BFR procedure 414 may be unsuccessful. For example, the base station 402 and the UE 404 may experience radio link failure (RLF). In such examples, the base station 402 and the UE 404 may perform an RLF procedure 416 to attempt to reestablish a radio link. In some examples, the RLF procedure 416 may be a last resort for the base station 402 and the UE 404 in attempting to maintain a connection.

As described above, a beamforming technology (e.g., 5G NR mmW technology) may use beam management procedures, such as beam measurements and beam switches, to maintain a quality of a link between a first device and a second device (e.g., an access link between a base station and a UE or a sidelink communication link between a first UE and a second UE) at a sufficient level for the accurate exchange of communication. Beam management procedures may support mobility and the selection of the best beam pairing (or beam pair link (BPL)) between the first device and the second device. Beam selection may be based on a number of considerations including logical state, power saving, robustness, mobility, throughput, etc. For example, wide beams (e.g., the example beams of FIG. 4B) may be used for initial connection and for coverage/mobility, while narrow beams (e.g., the example beams of FIG. 4C) may be used for high throughput scenarios with low mobility.

FIGS. 5A, 5B, and 5C illustrate an example of beam pair link (BPL) discovery and refinement. In 5G NR, P1, P2, and P3 procedures are used for BPL discovery and refinement.

A P1 procedure enables the discovery of new BPLs. Referring to FIG. 5A, in a P1 procedure 500, a base station 502 transmits different symbols of a reference signal (e.g., P1 signal), each beamformed in a different spatial direction. Stated otherwise, the base station 502 transmits beams using different transmit beams (e.g., transmit beams 510a, 510b, 510c, 510d, 510e, 510f) over time in different directions. For successful reception of at least a symbol of the P1 signal, a UE 504 searches for an appropriate receive beam. The UE 504 searches using available receive beams (e.g., receive beams 512a, 512b, 512c, 512d, 512e, 512f) and applying a different receive beam during each occurrence of the periodic P1 signal.

Once the UE 504 has succeeded in receiving a symbol of the P1 signal, the UE 504 has discovered a BPL. In some aspects, the UE 504 may not want to wait until it has found the best receive beam, as this may delay further actions. The UE 504 may measure a signal strength (e.g., reference signal receive power (RSRP)) and report the symbol index together with the RSRP to the base station 502. Such a report may contain the findings of one or more BPLs. In an example, the UE 504 may determine a received signal having a high RSRP. The UE 504 may not know which transmit beam the base station 502 used to transmit. However, the UE 504 may report to the base station 502 the time at which the signal having a high RSRP was observed. The base station 502 may receive this report and may determine which transmit beam the base station 502 used at the given time.

The base station 502 may then offer P2 and P3 procedures to refine an individual BPL. Referring to FIG. 5B, a P2 procedure 520 refines the beam (transmit beam) of a BPL at the base station 502. The base station 502 may transmit a set of symbols of a reference signal with different beams that are spatially close to the beam of the BPL (e.g., the base station 502 may perform a sweep using neighboring beams around the selected beam). For example, the base station 502 may transmit a plurality of transmit beams (e.g., a first transmit beam 522a, a second transmit beam 522b, and a third transmit beam 522c) over a consecutive sequence of symbols, with a different beam per symbol. In the P2 procedure 520, the UE 504 keeps its receive beam (e.g., a receive beam 524) constant. Thus, the UE 504 uses the same beam as in the BPL. The beams used by the base station 502 for the P2 procedure 520 may be different from those used for the P1 procedure in that they may be spaced closer together or they may be more focused. The UE 504 may measure the signal strength (e.g., RSRP) for the various beams (e.g., the first transmit beam 522a, the second transmit beam 522b, and the third transmit beam 522c) and indicate the strongest beam and/or the highest RSRP to the base station 502. Additionally, or alternatively, the UE 504 may indicate all RSRPs measured for the beams. The UE 504 may indicate such information via a CSI-RS resource indicator feedback message, which may contain the RSRPs of the received beams (e.g., the first transmit beam 522a, the second transmit beam 522b, and the third transmit beam 522c) in a sorted manner. The base station 502 may switch an active beam to the strongest beam reported, thus keeping the RSRP of the BPL at a highest level and supporting low mobility. If the transmit beams used for the P2 procedure 520 are spatially close (or even partially overlapped), no beam switch notification may be sent to the UE 504.

Referring to FIG. 5C, a P3 procedure 540 refines the beam (receive beam) of a BPL at the UE 504. In this example, the UE 504 transmits a same transmit beam 542 over a consecutive sequence of symbols. The UE 504 may use this opportunity to refine the receive beam by checking a strength of multiple receive beams (from the same or different panels). That is, while the transmit beam stays constant, the UE 504 may scan using different receive beams (e.g., the UE 504 performs a sweep using neighboring beams (e.g., a first receive beam 544a, a second receive beam 544b, and a third receive beam 544c)). The UE 504 may measure the RSRP of each receive beam and identify the best beam. Afterwards, the UE 504 may use the best beam for the BPL. The UE 504 may or may not send a report of RSRP(s) of the receive beam to the base station 502. By the end of the P2 procedure 520 and the P3 procedure 540, the refined transmit beam at the base station 502 and the refined receive beam at the UE 504 maximize the RSRP of the BPL.

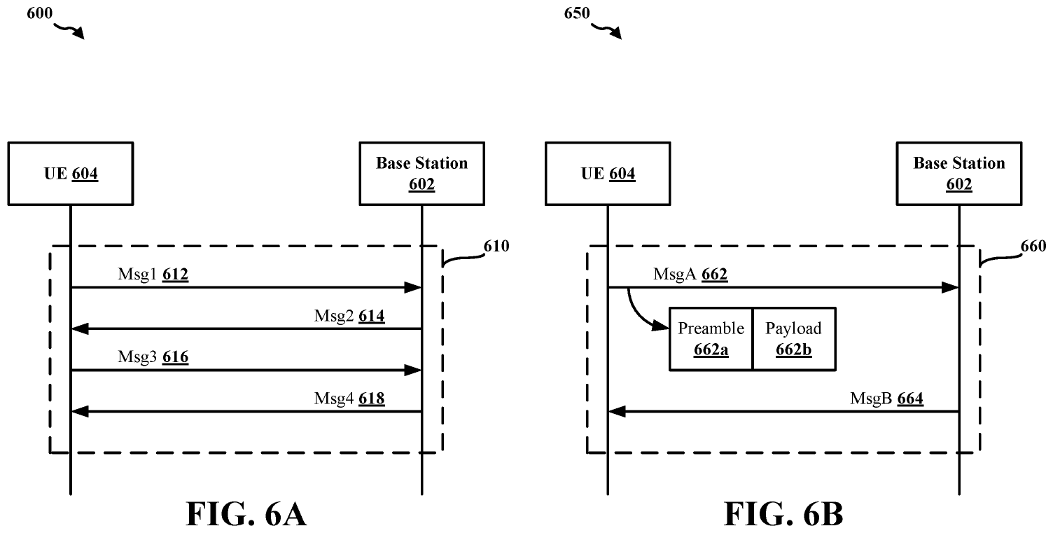

FIG. 6A is a diagram illustrating a communication flow 600 between a base station 602 and a UE 604 implementing a four-step RACH procedure 610. In the illustrated example of FIG. 6A, the four-step RACH procedure 610 includes the exchange of four messages. Specifically, the UE 604 may initiate the message exchange of the four-step RACH procedure 610 by sending, to the base station 602, a first four-step RACH message (e.g., a msg1 612) including a preamble (e.g., without a payload). The base station 602 then sends, to the UE 604, a second four-step RACH message (e.g., a msg2 614) including a random access response (RAR). In some aspects, the msg2 614 may include an identifier of the RACH preamble, a timing advance (TA), an uplink grant for the UE 604 to transmit data, cell radio network temporary identifier (C-RNTI), and/or a back-off indicator. The UE 604 then sends a third four-step RACH message (e.g., a msg3 616) to the base station 602. In some aspects, the msg3 616 may include a radio resource control (RRC) connection request, an RRC connection re-establishment request, or an RRC connection resume request, depending on the trigger for the UE 604 initiating the random access procedure. The base station 602 then completes the four-step RACH procedure 610 by sending a fourth four-step RACH message (e.g., a msg4 618) to the UE 604. In some aspects, the msg4 618 includes timing advancement information, contention resolution information, and/or RRC connection setup information.

Although not shown in the example of FIG. 6A, in some examples, the UE 604 may re-transmit a RACH message. For example, in some aspects, after transmitting the msg1 612, the UE 604 may re-transmit (e.g., periodically, a-periodically, and/or as a one-time event) the msg1 612. In some examples, the UE 604 may re-transmit the msg1 612 until the msg2 614 is received from the base station 602 and/or a timer expires. In other examples, the RACH message received by the UE 604 (e.g., the msg2 614 and/or the msg4 618) may indicate that the base station 602 is unable to process (e.g., decode) at least a portion of a RACH message transmitted by the UE 604. In some such examples, the UE 604 may then re-transmit the corresponding RACH message.

FIG. 6B is a diagram illustrating a communication flow 650 between the base station 602 and the UE 604 implementing a two-step RACH procedure 660. In the illustrated example of FIG. 6B, the two-step RACH procedure 660 includes the exchange of two messages. Specifically, the UE 604 may initiate the message exchange of the two-step RACH procedure 660 by sending a first two-step RACH message (e.g., a msgA 662) to the base station 602. Responsive to the msgA 662, the base station 602 may complete the message exchange of the two-step RACH procedure 660 by sending a second two-step RACH message (e.g., a msgB 664) to the UE 604.

In some aspects, to initiate the two-step RACH procedure 660, the UE 604 may generate the msgA 662. For the two-step RACH procedure 660, the UE 604 may generate the msgA 662 to include at least a preamble 662a (e.g., a PRACH preamble) and a payload 662b. In some aspects, the preamble 662a may correspond to the msg1 612 and the payload 662b may correspond to the msg3 616 of the four-step RACH procedure 610 of FIG. 6A.

The UE 604 may be identified by the base station 602 according to an identifier (ID) of the UE 604, such as a radio network temporary identifier (RNTI) (e.g., a random access (RA) RNTI, a temporary RNTI, etc.). The msgA 662 may be the first transmission by the UE 604 to the base station 602 and, therefore, the base station 602 may benefit from a mechanism for indicating the ID of the UE 604 to the base station 602 in the msgA 662, particularly because the msgA 662 may include data from the UE 604 in the payload 662b. Accordingly, the UE 604 may indicate an ID of the UE 604 using one or more (or a combination of) approaches for including information in the msgA 662.

In response to receiving the msgA 662, the base station 602 may generate the msgB 664. The base station 602 may generate the msgB 664 to include control information in a PDCCH and data in a PDSCH. The base station 602 may send the msgB 664 to the UE 604 to complete the two-step RACH procedure 660. In some aspects, information included in the msgB 664 may correspond to the msg2 614 and the msg4 618 of the four-step RACH procedure 610 of FIG. 6A. The UE 604 may receive the msgB 664, and the UE 604 may acquire timing synchronization based on the msgB 664.

Although not shown in the example of FIG. 6B, in some aspects, the UE 604 may re-transmit a RACH message. For example, in some aspects, after transmitting the msgA 662, the UE 604 may re-transmit (e.g., periodically, a-periodically, and/or as a one-time event) the msgA 662. The UE 604 may re-transmit the msgA 662 until the msgB 664 is received from the base station 602 and/or a timer expires. In some examples, the RACH response message received by the UE 604 (e.g., the msgB 664) may indicate that the base station 602 is unable to process (e.g., decode) at least a portion of the RACH message. In some such examples, the UE 604 may then re-transmit the corresponding RACH message. For example, the base station 602 may transmit a RACH message indicating that the base station 602 is unable to decode the payload 662b of the msgA 662 and the UE 604 may re-transmit the msgA 662.

While the two-step RACH procedure 660 of FIG. 6B differs in some aspects from the four-step RACH procedure 610 of FIG. 6A, some aspects may be common across the RACH procedures. For example, sequences associated with a physical RACH (PRACH) and sequences associated with DMRS used for the four-step RACH procedure 610 may also be used for the two-step RACH procedure 660.

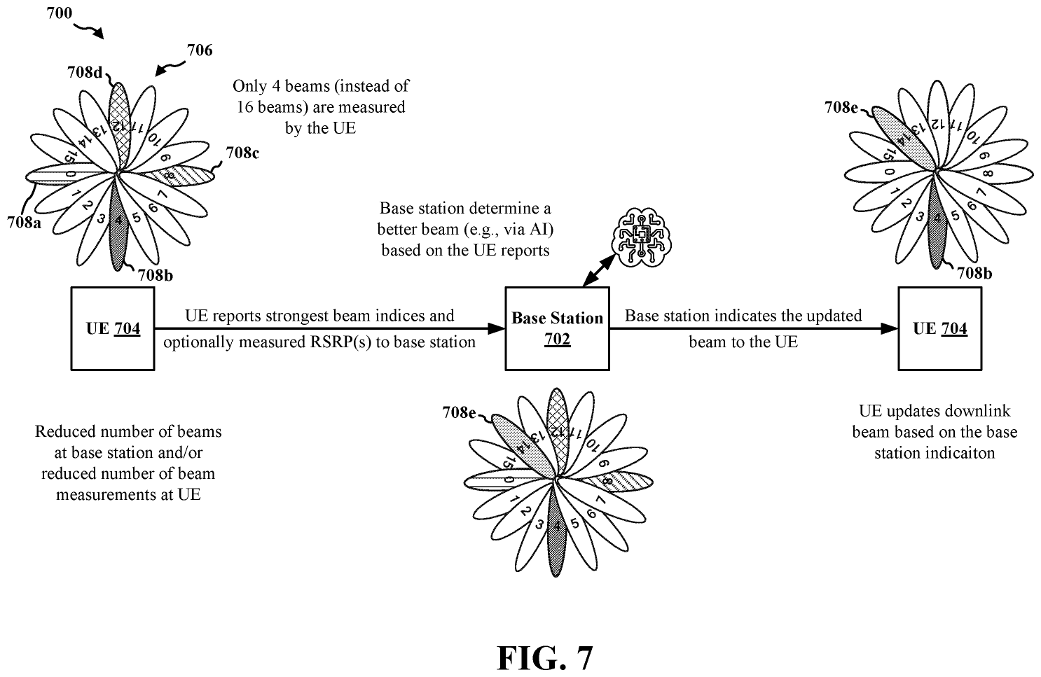

FIG. 7 illustrates an example communication flow 700 between a base station 702 and a UE 704, as presented herein. In the illustrated example of FIG. 7, the base station 702 may transmit an SSB burst set 706 that is received by the UE 704. In the example of FIG. 7, the SSB burst set 706 includes sixteen beams (e.g., “SSB0”, “SSB1,” “SSB15”). The UE 704 may perform measurements for a reduced quantity of beams of the SSB burst set 706. For example, the UE 704 may measure a first beam 708a (e.g., an SSB0), a second beam 708b (e.g., an SSB4), a third beam 708c (e.g., an SSB8), and a fourth beam 708d (e.g., an SSB12). Examples of measurement information may include a signal strength (e.g., RSRP) associated with each beam.

As shown in FIG. 7, the UE 704 may report the strongest beam indices (e.g., indices of the strongest beams) to the base station 702. The UE 704 may also report the measured RSRP of the strongest beam to the base station 702. The base station 702 and the UE 704 may then establish a connection based on the reported strongest beam indices and/or the measured RSRP. For example, the base station 702 and the UE 704 may transmit and receive messages of a RACH procedure based on the strongest beam indices and/or the measured RSRP.

In some examples, the base station 702 may determine an alternate beam for communication with the UE 704. The base station 702 may determine the alternate beam based in part on the reported strongest beam indices and/or the measured RSRP. For example, the base station 702 may determine an updated beam 708e (e.g., an SSB14) for communication with the UE 704. In some examples, the base station 702 may use artificial intelligence (AI) techniques and/or machine learning (ML) techniques to determine the alternate beam. For example, based on the reported strongest beam indices and/or the measured RSRP, and additional inputs, such as environmental factors, traffic type, mobility, etc., the base station 702 may determine that the updated beam 708e is the beam to use to communicate with the UE 704.

As shown in FIG. 7, the base station 702 may indicate the updated beam 708e to the UE 704. The UE 704 may then update the downlink beam based on the indication from the base station 702. For example, the UE 704 may report an index corresponding to the second beam 708b to the base station 702 based on measurements performed on the first beam 708a, the second beam 708b, the third beam 708c, and the fourth beam 708d. The UE 704 may then set the second beam 708b as the downlink beam for receiving downlink communications from the base station 702. For example, the UE 704 may use the second beam 708b to receive downlink messages from the base station 702 while performing a RACH procedure. After establishing a connected mode state, the base station 702 may transmit an indicator of the updated beam 708e to the UE 704. In some examples, the base station 702 may dynamically indicate the updated beam 708e, for example, by transmitting the indication of the updated beam 708e via DCI and/or a MAC control element (MAC-CE). The UE 704 may then update its downlink beam based on the indication received from the base station 702.

In some examples, after receiving the indication of the updated beam 708e from the base station 702, the UE 704 may reject the alternate beam and indicate to the base station 702 to continue using the original downlink beam (e.g., the second beam 708b reported to the base station 702). In some examples, the UE 704 may indicate a different beam to the base station 702 to use for downlink communications to the UE 704. For example, the UE 704 may indicate a beam that is different from the original downlink beam (e.g., the second beam 708b) and different from the alternate beam (e.g., the updated beam 708e).

Although the example of FIG. 7 illustrates that the base station 702 transmits sixteen beams that may be received by the UE 704, in other example, the quantity of beams may be any suitable quantity of beams, such as four beams, 32 beams, 64 beams, etc.

Although the example of FIG. 7 describes the UE 704 performing measurements on a reduced quantity of beams, in other examples, the base station 702 may reduce the quantity of beams included in the beam sweep. For example, instead of transmitting the sixteen beams of the SSB burst set 706, the base station 702 may transmit the first beam 708a, the second beam 708b, the third beam 708c, and the fourth beam 708d. In such scenarios, the UE 704 may perform measurements on each of the four received beams. In other examples, the base station 702 may transmit a reduced quantity of SSBs and the UE 704 may perform measurements on a subset of the reduced quantity of SSBs. For example, the base station 702 may transmit the first beam 708a, the second beam 708b, the third beam 708c, and the fourth beam 708d, and the UE 704 may perform measurements on the second beam 708b and the fourth beam 708d.

In some examples, it may be beneficial for the UE 704 to report multiple beams to the base station 702. For example, the UE 704 may report indices for multiple respective beams. In some examples, the UE 704 may report the SSB indices and/or measurement information (e.g., RSRPs) via a message of a RACH procedure. For example, the UE 704 may report the SSB indices and/or the measurement information via a msg1 and/or msg3 of a four-step RACH procedure (e.g., the msg1 612 and/or the msg3 616 of the four-step RACH procedure 610 of FIG. 6A). In other examples, the UE 704 may report the SSB indices and/or the measurement information via a msgA of a two-step RACH procedure (e.g., the msgA 662 of the two-step RACH procedure 660 of FIG. 6B).

However, for each beam that the UE 704 reports to the base station 702, the UE 704 may include an index value and/or measurement information (e.g., an RSRP). In such examples, each additional beam reported may introduce overhead that may reduce communication performance and/or increase latency in communication between the base station 702 and the UE 704.

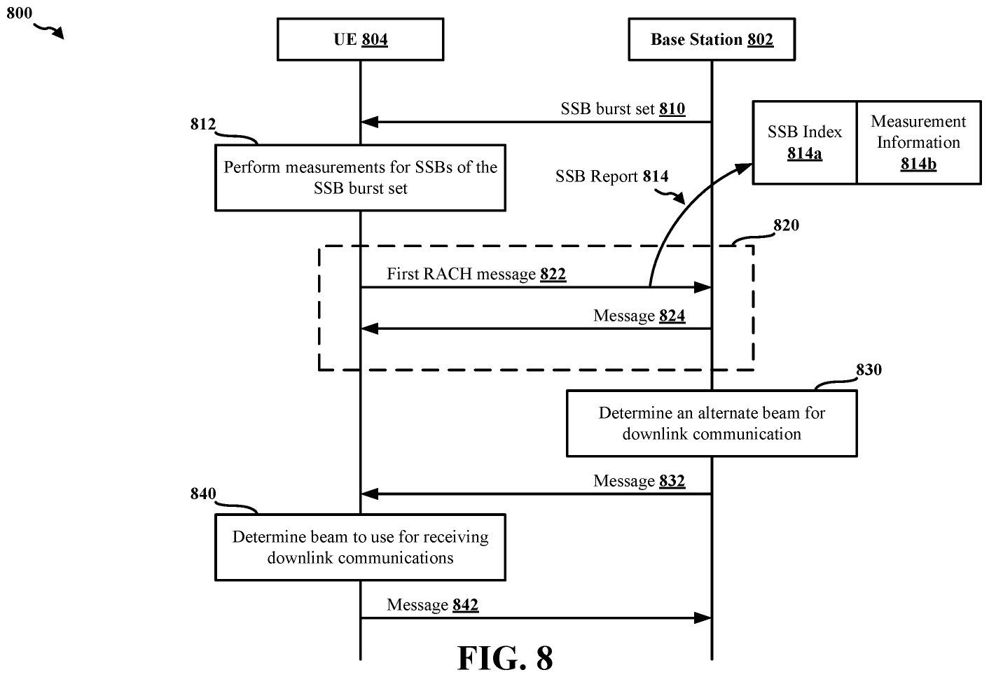

FIG. 8 illustrates an example communication flow 800 between a base station 802 and a UE 804, as presented herein. Aspects of FIG. 8 may be similar to the communication flow 700 of FIG. 7. In the illustrated example of FIG. 8, the base station 802 may transmit an SSB burst set 810 that is received by the UE 804. For example, the base station 802 may transmit the SSB burst set 706 of FIG. 7 including sixteen beams (e.g., “SSB0”, “SSB1,” . . . “SSB15”). The UE 804 may perform measurements, at 812, for SSBs of the SSB burst set 810. In some examples, the UE 804 may perform measurements for a reduced quantity of beams of the SSB burst set 810. For example, the UE 804 may measure the first beam 708a (e.g., the SSB0), the second beam 708b (e.g., the SSB4), the third beam 708c (e.g., the SSB8), and the fourth beam 708d (e.g., the SSB12) of FIG. 7.

As shown in FIG. 8, the UE 804 may transmit an SSB report 814 that may be received by the base station 802. The SSB report 814 may include an SSB index 814a of the strongest beam (e.g., the second beam 708b). The SSB report 814 may also include measurement information 814b (e.g., a measured RSRP) associated with the strongest beam. In examples in which the UE 804 reports information for multiple SSBs, the UE 804 may transmit multiple SSB reports associated with each of the reported SSBs. For example, the UE 804 may transmit a first SSB report associated with the first beam 708a, may transmit a second SSB report associated with the second beam 708b, may transmit a third SSB report associated with the third beam 708c, and/or may transmit a fourth SSB report associated with the fourth beam 708d.

In some examples, the UE 804 may transmit the SSB report 814 while performing a RACH procedure 820 with the base station 802. For example, the UE 804 may transmit the SSB report 814 in a first RACH message 822 of the RACH procedure 820. In some examples, the first RACH message 822 may be part of a four-step RACH procedure (e.g., a preamble of a “msg1”). Aspects of a four-step RACH procedure are described in connection with an example communication flow 600 of FIG. 6A. In other examples, the first RACH message 822 may be part of a two-step RACH procedure (e.g., a preamble of a “msgA”). Aspects of a two-step RACH procedure are described in connection with an example communication flow 650 of FIG. 6B.

As shown in FIG. 8, the base station 802 transmits a message 824 that is received by the UE 804. The message 824 may be part of the RACH procedure 820. For example, the message 824 may be a message of the four-step RACH procedure (e.g., a “msg2” or a “msg4”). In other examples, the message 824 may be a message of the two-step RACH procedure (e.g., a “msgB”). The base station 802 may transmit the message 824 based on the SSB report 814. For example, the SSB report 814 may indicate that the second beam 708b is the strongest beam and, thus, the base station 802 may use the second beam 708b to transmit the message 824.

In some examples, the base station 802 may be configured to determine an alternate beam based at least in part on the SSB report 814. For example, at 830, the base station 802 may determine an alternate beam for downlink communication with the UE 804. Similar to the example of FIG. 7, the base station 802 may determine that the updated beam 708e (e.g., an SSB14) is a preferred beam for communication with the UE 804. In some examples, the base station 802 may use AI techniques and/or ML techniques to determine the alternate beam. For example, based on the information included in the SSB report 814 and additional inputs, such as environmental factors, traffic type, mobility, etc., the base station 802 may determine that the updated beam 708e is the preferred beam to use to communicate with the UE 804.

In some examples, the alternate beam may be a beam reported by the UE 804 to the base station 802. For example, the UE 804 may transmit respective SSB reports for each of the first beam 708a, the second beam 708b, the third beam 708c, and the fourth beam 708d. Based on the received SSB reports, the base station 802 may determine that the fourth beam 708d is the preferred beam to use for downlink communication with the UE 804.

As shown in FIG. 8, the base station 802 may transmit a message 832 indicating the alternate beam (e.g., the updated beam 708e or the fourth beam 708d) to use for communication. The base station 802 may transmit the message 832 after establishing an RRC connection with the UE 804. For example, the base station 802 and the UE 804 may complete the RACH procedure 820 to facilitate a connected mode at the UE 804 (e.g., the example connected mode state 412 of FIG. 4A). The base station 802 may then transmit the message 832 to indicate the alternate beam via DCI and/or a MAC-CE.

The UE 804 may determine, at 840, a beam to use for receiving downlink communications from the base station 802. In some examples, the UE 804 may determine to use the beam indicated in the message 832 (e.g., the alternate beam). For example, the UE 804 may update its downlink beam for communicating with the base station 802 to the updated beam 708e or the fourth beam 708d.

In some examples, the UE 804 may determine, at 840, to use the original beam for receiving downlink communications from the base station 802. For example, the UE 804 may determine to use the second beam 708b indicated in the SSB report 814. In such scenarios, the UE 804 may transmit a message 842 indicating that the UE 804 is preparing to receive downlink communications from the base station 802 via the second beam 708b.

Although the example of FIG. 8 describes the UE 804 performing measurements on a reduced quantity of beams, in other examples, the base station 802 may reduce the quantity of beams included in the beam sweep. For example, instead of transmitting the sixteen beams of the SSB burst set 706, the base station 802 may transmit the first beam 708a, the second beam 708b, the third beam 708c, and the fourth beam 708d. In such scenarios, the UE 804 may perform measurements on each of the four received beams. In other examples, the base station 802 may transmit a reduced quantity of SSBs and the UE 804 may perform measurements on a subset of the reduced quantity of SSBs. For example, the base station 802 may transmit the first beam 708a, the second beam 708b, the third beam 708c, and the fourth beam 708d, and the UE 804 may perform measurements on the second beam 708b and the fourth beam 708d.

In some examples, the RACH procedure 820 may be performed using a single UE-preferred beam. For example, the SSB report 814 may include the SSB index 814a of a single strongest beam (e.g., the second beam 708b). In some examples, the SSB report 814 may additionally, or alternatively, include the measurement information 814b (e.g., the RSRP) for the single strongest beam. The single UE-preferred beam may be based on multiple SSB measurements, which may increase latency while performing an initial access procedure (e.g., the initial access procedure 410 of FIG. 4A) and/or while performing a BFR procedure (e.g., the BFR procedure 414 of FIG. 4A).

As described above, in some examples, it may be beneficial for the UE 804 to report multiple beams. For example, the UE 804 may transmit multiple SSB reports for respective beams. In some examples, the UE 804 may report the SSB indices and/or measurement information (e.g., RSRPs) via a message of the RACH procedure 820. For example, the UE 804 may report the SSB indices and/or measurement information via a msg1 and/or msg3 of a four-step RACH procedure (e.g., the msg1 612 and/or the msg3 616 of the four-step RACH procedure 610 of FIG. 6A). In other examples, the UE 804 may report the SSB indices and/or measurement information via a msgA of a two-step RACH procedure (e.g., the msgA 662 of the two-step RACH procedure 660 of FIG. 6B).

In some examples, for each beam that the UE 804 reports to the base station 802, the UE 804 may include an index value and/or measurement information (e.g., an RSRP). However, the UE 804 may be configured to report a single SSB index and related measurement information through an associated RACH occasion (RO) and/or an associated preamble. Thus, each additional beam that the UE 804 reports may introduce overhead that may reduce communication performance and/or increase latency.

Additionally, as described above, the base station 802 may indicate the alternate beam after RRC connection setup (e.g., after the UE 804 is operating in the connected mode state 412 of FIG. 4A). For example, the ability to dynamically indicate the updated downlink beam (e.g., the updated beam 708e) may be based on a transmission configuration indication (TCI) state update configured via RRC, MAC-CE TCI-states activation, and/or DCI indicating an activated TCI-state codepoint.

Aspects disclosed herein facilitate providing a pre-grouping of SSBs from the base station. The UE may obtain the pre-grouping and report a group index for a subset of SSBs to the base station. The reported group index may be based on measurements performed on the SSBs of the subset of SSBs. In some examples, the UE may also report a beam strength ordering for the SSBs of the subset of SSBs and/or measurement information for the respective SSBs in the subset of SSBs. By reporting a group index for a subset of SSBs, the UE may reduce the overhead associated with transmitting multiple SSB reports indicating the multiple beams as the multiple respective indices and/or measurement information may be indicated via a group index instead of each being individually reported. The UE may transmit the group index via a message of a RACH procedure (e.g., the msg1 of a four-step RACH procedure or the msgA of a two-step RACH procedure).

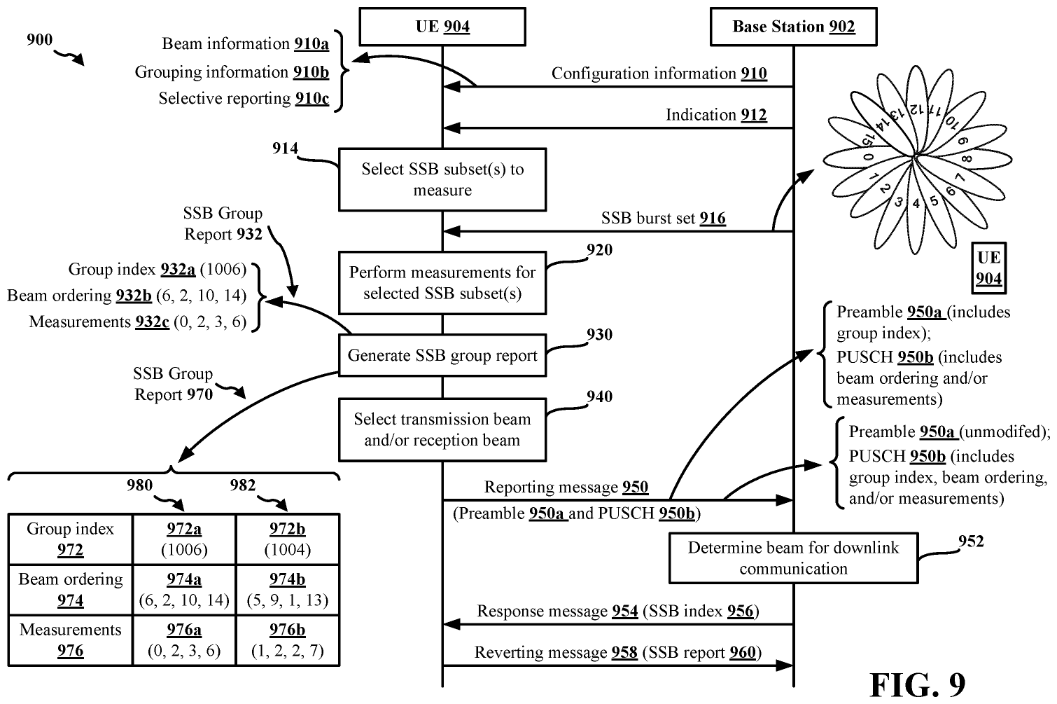

FIG. 9 illustrates an example communication flow 900 between a base station 902 and a UE 904, as presented herein. Aspects of the base station 902 may be implemented by the base station 102/180 of FIG. 1 and/or the base station 310 of FIG. 3. Aspects of the UE 904 may be implemented by the UE 104 of FIG. 1 and/or the UE 350 of FIG. 3. Although not shown in the illustrated example of FIG. 9, it may be appreciated that in additional or alternative examples, the base station 902 may be in communication with one or more other base stations or UEs, and/or the UE 904 may be in communication with one or more other base stations or UEs.

In the illustrated example, the communication flow 900 facilitates the UE 904 performing SSB-subset selection-based RACH with base station-side beam prediction. For example, the communication flow 900 enables the UE 904 to reduce overhead when reporting SSB indices and related measurement information by providing a group index that corresponds to one or more SSB subsets of an SSB burst set. In some examples, the UE 904 may additionally or alternatively report an ordering of the SSBs within a reported SSB subset. The ordering may be based on measurement information, such as RSRP (e.g., layer 1 RSRP) associated with each beam and/or a signal to interference and noise ratio (SINR) associated with each beam. For example, the UE 904 may order the SSBs within the reported SSB subset based on RSRP measurements of the respective SSBs. The UE 904 may measure SINR to improve performance when performing a BFR procedure, such as the example BFR procedure 414 of FIG. 4A. In some examples, the ordering may be based on reporting the one or more strongest SSB indices. In some examples, the ordering may be based on an explicit ordering report.

As shown in FIG. 9, the base station 902 may transmit configuration information 910 that is received by the UE 904. In some examples, the UE 904 may receive the configuration information 910 before establishing a connection with the base station 902. For example, the base station 902 may broadcast the configuration information 910 with RACH configurations included in system information, such as remaining minimum system information (RMSI). In such examples, the configuration information 910 may be received by the UE 904 and any additional UEs within the coverage area of the base station 902.

In some examples, the UE 804 may receive the configuration information 910 after establishing a connection with the base station 902 (e.g., while operating in the connected mode state 412 of FIG. 4A). For example, the base station 902 may transmit the configuration information 910 to the UE 904 via RRC signaling as RRC configurations while the UE 904 is operating in the connected mode state.

The configuration information 910 may provide information related to the SSBs of an SSB burst set. For example, the configuration information 910 may indicate beam information 910a related to the SSBs of the SSB burst set, such as transmission beam direction information, transmission beam angular spread information (e.g., how much the wave spreads in 2-D or 3-D), and/or transmission beam angle separation between two or more beams. The transmission beam direction information and the transmission beam angle separation information of an SSB beam may be defined in terms of the boresight direction of the SSB beam. The boresight direction may be the direction of the microwave propagation and may be perpendicular to the wavefront. In some examples, the transmission beam direction information of an SSB beam may be defined based on at least one of antenna coordinates of the base station 902, and elevation and/or azimuth angle of the SSB beam. The transmission beam angle separation information may be defined between adjacent SSBs within a same SSB subset. In other examples, the transmission beam angle separation information may be defined between two or more SSBs associated with different SSB subsets.

The configuration information 910 may also include grouping information 910b indicating one or more grouping options associated with the SSBs of the SSB burst set. For example, the configuration information 910 may indicate a first grouping option in which the SSBs of the SSB burst set are grouped into two SSB subsets (e.g., each SSB subset includes eight SSBs) and a second grouping option in which the SSBs of the SSB burst set are grouped into four SSB subsets (e.g., each SSB subset includes fourth SSBs).

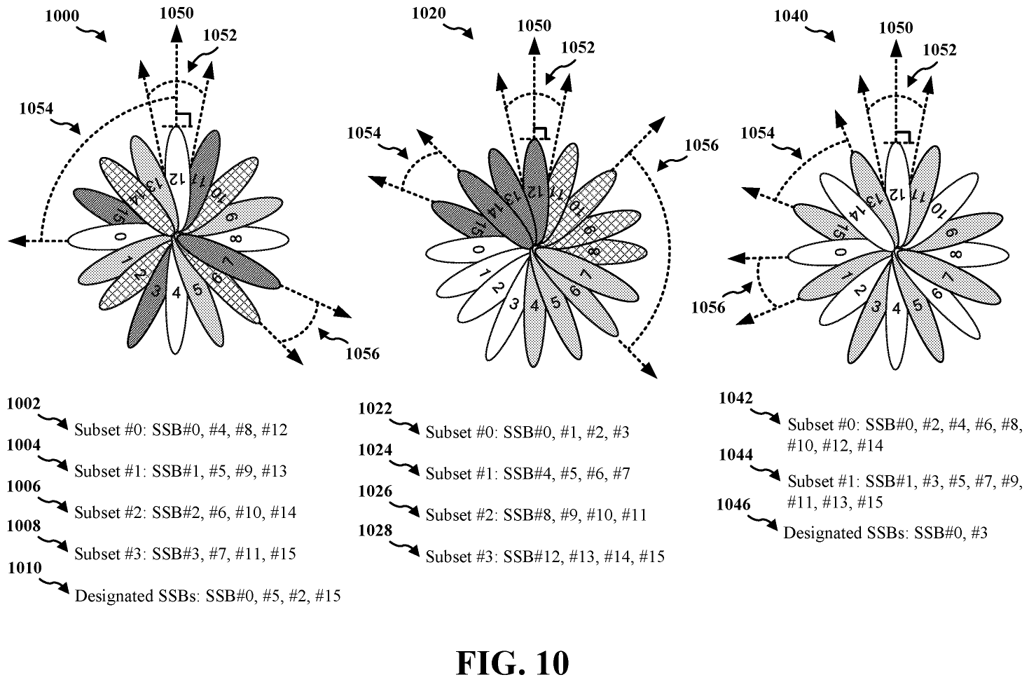

FIG. 10 illustrates example grouping options of SSB subsets that may be indicated via the configuration information 910 of FIG. 9, as presented herein. For example, the configuration information 910 may indicate a first SSB grouping 1000, a second SSB grouping 1020, and a third SSB grouping 1040. As shown in FIG. 10, the SSBs of the first SSB grouping 1000 and the second SSB grouping 1020 are grouped into four subsets. For example, the first SSB grouping 1000 includes a first subset 1002 (“Subset #0”), a second subset 1004 (“Subset #1”), a third subset 1006 (“Subset #2”), and a fourth subset 1008 (“Subset #3”). The SSBs of the first SSB grouping 1000 are interlaced to cover different directions. For example, the first subset 1002 includes SSB indices 0, 4, 8, and 12, the second subset 1004 includes SSB indices 1, 5, 9, and 13, the third subset 1006 includes SSB indices 2, 6, 10, and 14, and the fourth subset 1008 includes SSB indices 3, 7, 11, and 15.

In another example grouping option of SSBs of an SSB burst set, the second SSB grouping 1020 includes a first subset 1022 (“Subset #0”), a second subset 1024 (“Subset #1”), a third subset 1026 (“Subset #2”), and a fourth subset 1028 (“Subset #3”). The SSBs of the second SSB grouping 1020 are grouped as adjacent beams. For example, the first subset 1022 includes SSB indices 0 to 3, the second subset 1024 includes SSB indices 4 to 7, the third subset 1026 includes SSB indices 8 to 11, and the fourth subset 1028 includes SSB indices 12 to 15.

In another example grouping option of SSBs of an SSB burst set, the third SSB grouping 1040 includes a first subset 1042 (“Subset #0”) and a second subset 1044 (“Subset #1”). The grouping of SSBs of the third SSB grouping 1040 in their respective subsets are based on alternating beams. For example, the first subset 1042 includes SSB indices 0, 2, 4, 6, 8, 10, 12, and 14, and the second subset 1044 includes SSB indices 1, 3, 5, 7, 9, 11, 13, and 15.

It may be appreciated that the example grouping options of the first SSB grouping 1000, the second SSB grouping 1020, and the third SSB grouping 1040 are illustrative, and that other examples may include additional or alternate groupings.

Although the example SSB groupings of the first SSB grouping 1000 and the second SSB grouping 1020 each include four SSBs, other examples may include any suitable quantity of SSBs in an SSB subset. For example, the SSBs of the first SSB grouping 1000 may be grouped into two SSB subsets including eight SSBs each, as shown in the third SSB grouping 1040. In another example, the SSBs of an SSB burst set may be grouped into four SSB subsets in which two SSB subsets may each include two SSBs and two SSB subsets may each include six SSBs.

In some examples, the configuration information 910 may also include beam information associated with the SSBs of the SSB burst set. For example, the configuration information 910 may include a transmission beam direction, a transmission beam angular spread, a transmission beam angle separation between adjacent SSBs within the same SSB subset, and/or a transmission beam angle separation between at least two SSBs within different SSB subsets. For example, the transmission beam direction may correspond to a direction 1050 that the SSB12 is directed. The transmission beam angular spread may correspond to a first angle 1052 associated with the SSB12. The transmission beam angle separation between adjacent SSBs within the same SSB subset may correspond to a second angle 1054. The transmission beam angle separation between at least two SSBs within different SSB subsets may correspond to a third angle 1056.

In some example, the measurement information for different grouping options may be associated with different quantization granularities. For example, and referring to the first SSB grouping 1000 and the third SSB grouping 1040, the first SSB grouping 1000 includes four SSBs in each respective SSB subset and the third SSB grouping 1040 includes eight SSBs in each respective SSB subset. Thus, the measurement information (e.g., RSRP and/or SINR) reported for the first SSB grouping 1000 may have higher quantization resolution than the measurement information reported for the third SSB grouping 1040 as there are fewer SSBs for which measurement information is reported. For example, the measurement information may be reported as a codepoint where the value of the codepoint indicates a step-size and/or a dynamic range of measurements. The length of the codepoints may be smaller when reporting measurement information associated with the third SSB grouping 1040 compared to the length of the codepoints when reporting measurement information associated with the first SSB grouping 1000. As the length of the codepoint increases, the step-size associated with each codepoint decreases, which may allow for improved quantization granularity. For example, the codepoints associated with the third SSB grouping 1040 may be three bits long and associated with a range of 20 decibels (dBs), while each codepoint associated with the first SSB grouping 1000 may be five bits long and associated with a range of 5 dBs.

Referring again to the communication flow 900 of FIG. 9, the base station 902 may transmit an SSB burst set 916 and one or more beams of the SSB burst set 916 may be received by the UE 904. In the illustrated example of FIG. 9, the SSB burst set 916 includes sixteen beams. However, other examples may include any suitable quantity of beams.

The UE 904 performs, at 920, measurements for one or more SSB subsets. For example, the UE 904 may measure the signal strength (e.g., RSRP) and/or interference (e.g., SINR) associated with each beam of an SSB subset.

In some examples, the base station 902 may transmit an indication 912 to measure one or more SSB subsets of the SSB burst set 916. For example, the indication 912 may indicate that the UE 904 is to measure the SSBs associated with the second subset 1004 of the first SSB grouping 1000 of FIG. 10.

In some examples, the UE 904 may be configured to determine the one or more SSB subsets on which to perform the measurements. For example, at 914, the UE 904 may select the one or more SSB subsets to measure. In examples in which the UE 904 is configured with multiple SSB grouping options, the UE 904 may select an SSB grouping and then select one or more SSB subsets of the selected SSB grouping. In some examples, the UE 904 may apply signal processing techniques, AI techniques, and/or ML techniques to determine the SSB grouping option and the one or more SSB subsets on which to perform measurements.

For example, in the example of FIG. 9, the UE 904 may be located at a position that is between SSB5 and SSB6 of the SSB burst set 916. The UE 904 may also have the ability to perform measurements on the SSBs of the first SSB grouping 1000 and the third SSB grouping 1040. In some examples, the UE 904 may select the SSB grouping based on a quantization resolution. For example, the UE 904 may select the first SSB grouping 1000 to provide high quantization resolution for the measurement information, or may select the third SSB grouping 1040 when low quantization resolution for the measurement information is acceptable. After selecting the SSG grouping, the UE 904 may also use the beam information 910a associated with the SSB5 and the SSB6 to determine which SSB subset of the selected SSB grouping to measure. For example, based on the beam information 910a associated with the SSB5 and the SSB6, the UE 904 may determine to select the SSB subset including the SSB6 (e.g., the third subset 1006 of the first SSB grouping 1000 or the first subset 1042 of the third SSB grouping 1040).

Although the example of FIG. 9 illustrates that the UE 904 receives the beam information 910a via the configuration information 910, in other examples, the UE 904 may have the ability to determine one or more aspects of the beam information 910a for the beams of the SSB burst set 916. In such examples, the UE 904 may use the determined aspects of the beam information 910a to determine the one or more SSB subsets to measure.

After performing the measurements for the selected SSB subset(s), the UE 904 generates, at 930, an SSB group report 932. The SSB group report 932 may include one or more components. For example, the SSB group report 932 may include a group index component 932a, a beam ordering component 932b, and/or a measurements component 932c. The group index component 932a may indicate the selected grouping option and the selected SSB subset. For example, the group index component 932a may indicate that the reported SSBs are associated with the third subset 1006 of the first SSB grouping 1000.

The beam ordering component 932b may indicate an ordering of the beams of the selected SSB subset. In some examples, the beams may be ordered based on beam strengths associated with each beam of the selected SSB subset. For example, the UE 904 may determine that the beam strengths associated with the beams of the third subset 1006 indicate that SSB6 is the strongest, followed by SSB2, then SSB10, and then SSB14. In such examples, the beam ordering component 932b may include a beam ordering [6, 2, 10, 14] indicating the ordering of the beam strengths associated with the SSBs of the third subset 1006.

The measurements component 932c may indicate the measurements associated with each of the beams of the selected SSB subset (e.g., the third subset 1006) and may include the measurements in the order indicated by the beam ordering component 932b. In the example of FIG. 9, the measurements are indicated via codepoints, where each codepoint corresponds to a respective measurement range (e.g., a range of decibels) and a smaller codepoint corresponds to a stronger beam strength. For example, the measurements component 932c may include measurements [0, 2, 3, 6]. The measurement “0” corresponds to a beam strength for the SSB6 and is associated with a strongest measurement range, the measurement “2” corresponds to a beam strength for the SSB2 that is less than the measured beam strength for the SSB6, the measurement “3” corresponds to a beam strength for the SSB10 that is less than the measured beam strength for the SSB2, and the measurement “6” corresponds to a beam strength for the SSB14 that is less than the measured beam strength for the SSB10.

In some examples, the UE 904 may perform selective measurement reporting. For example, the UE 904 may report the measurement information (e.g., L1-RSRP and/or L1-SINR) of a selective number of the SSBs within the selected SSB subset. For example, while the third subset 1006 of the first SSB grouping 1000 includes four SSBs, the UE 904 may report measurements for k SSBs of the third subset 1006. In some examples, the k SSBs may correspond to specific SSBs of the selected SSB subset. For example, the k SSBs may correspond to SSB6 and SSB10 of the third subset 1006. In other examples, the k SSBs may correspond to the k strongest SSBs of the selected SSB subset. For example, the value of k may be three and, thus, the measurements component 932c of the SSB group report 932 may include the measurements for the SSB6, the SSB2, and the SSB10.

In some examples, the k SSBs of the selected SSB subset may be configured by the base station 902. For example, the configuration information 910 may include a selective reporting parameter 910c (e.g., k) that indicates a particular number of SSBs and/or particular SSBs of a selected SSB subset to report.

In some examples, the k SSBs of the selected SSB subset may be determined and reported by the UE 904. For example, the k SSBs may be selected based on a criteria, such as the k strongest SSBs. In such examples, the UE 904 may report the measurements for the k strongest beams of the selected SSB subset. In some such examples, the value of k may be configured by the base station (e.g., via the selective reporting parameter 910c).

While the UE 904 is reporting on multiple SSBs (e.g., via the selected SSB subset), the UE 904 selects, at 940, a transmission beam and/or a receive beam to use for a RACH procedure. For example, the UE 904 may select a transmission (TX) beam to use to transmit a first RACH message (e.g., the msg1 612 of FIG. 6A or the msgA 662 of FIG. 6B). The UE 904 may also select a receive (RX) beam to receive a RACH response message (e.g., the msg2 614 of FIG. 6B or the msgB 664 of FIG. 6B).

The selected TX beam/RX beam may correspond to a designated SSB within the selected SSB subset. In some examples, the designated SSB, which may sometimes be referred to as a “leading SSB,” may be configured by the base station 902. For example, the grouping information 910b of the configuration information 910 may indicate a designated SSB for each SSB subset. Referring to the example grouping options of FIG. 10, the SSB groupings include a respective designated SSB for each of the SSB subsets. For example, the first SSB grouping 1000 includes designated SSBs 1010 indicating that the SSB0 is the designated SSB for the first subset 1002, that the SSB5 is the designated SSB for the second subset 1004, that the SSB2 is the designated SSB for the third subset 1006, and that the SSB15 is the designated SSB for the fourth subset 1008. Similarly, the third SSB grouping 1040 includes designated SSBs 1046 indicating that the SSB0 is the designated SSB for the first subset 1042, and that the SSB3 is the designated SSB for the first subset 1042. Thus, when the UE 904 selects an SSB subset to report (e.g., the third subset 1006), the UE 904 may use the designated SSB corresponding to the selects SSB subset (e.g., the SSB2 of the third subset 1006).

In other examples, the UE 904 may select the designated SSB. For example, the UE 904 may select the SSB associated with the strongest signal strength as the designated SSB of the corresponding SSB subset. For example, and referring to the example beam strength ordering [6, 2, 10, 14] associated with the third subset 1006 of the first SSB grouping 1000, the UE 904 may select the SSB6 as the designated SSB.

The UE 904 may indicate the selected designated SSB to the base station 902 based on a RACH occasion or a preamble partitioning. For example, the first subset 1002 of the first SSB grouping 1000 may be allocated four RACH occasions and/or four preambles. Each of the RACH occasions/preambles may map to different SSB of the first subset 1002. For example, a first RACH occasion or preamble may indicate that the first subset 1002 is the selected SSB subset and that the SSB0 is the designated SSB, a second RACH occasion or preamble may indicate that the first subset 1002 is the selected SSB subset and that the SSB4 is the designated SSB, a third RACH occasion or preamble may indicate that the first subset 1002 is the selected SSB subset and that the SSB8 is the designated SSB, a fourth RACH occasion or preamble may indicate that the first subset 1002 is the selected SSB subset and that the SSB12 is the designated SSB, . . . , a ninth RACH occasion or preamble may indicate that the third subset 1006 is the selected SSB subset and that the SSB2 is the designated SSB, a tenth RACH occasion or preamble may indicate that the third subset 1006 is the selected SSB subset and that the SSB6 is the designated SSB, etc. Thus, when the UE 904 selects an SSB subset to report (e.g., the third subset 1006) and determines a strongest SSB (e.g., the SSB6), the UE 904 may use the corresponding RACH occasion or preamble (e.g., the tenth RACH occasion or preamble) to indicate that the third subset 1006 is the selected SSB subset and that the SSB6 is the designated SSB.

It may be appreciated that when the designated SSB associated with an SSB subset is configured by the base station 902, the designated SSB may not correspond to the strongest SSB. For example, based on the measurements performed on the SSBs of the third subset 1006, the UE 904 may determine that the SSB6 is the strongest SSB of the third subset 1006. However, based on the designated SSBs 1010 configured by the base station 902 for the first SSB grouping 1000, the UE 904 may select, at 940, the SSB2 as the designated SSB.

In some examples, the UE 904 may select, at 940, the TX beam/RX beam based on the group of SSBs within the selected SSB subset. For example, the UE 904 may be located between the SSB5 and the SSB6 and the UE 904 may select the second SSB grouping 1020 from which to select the SSB subset. In such examples, the UE 904 may select, at 914, the second subset 1024 of the second SSB grouping 1020 to report to the base station 902. The UE 904 may also select, at 940, the SSB5 or the SSB6 as the TX beam/RX beam.

As shown in FIG. 9, after generating the SSB group report 932, the UE 904 transmits the SSB group report 932 to the base station 902. For example, the UE 904 may include the SSB group report 932 in a reporting message 950 to the base station 902. The UE 904 may use the selected TX beam to transmit the reporting message 950. The reporting message 950 may include one or more uplink messages of a RACH procedure or an uplink message before an RRC connection is established. As shown in FIG. 9, the reporting message 950 includes a preamble 950a and a PUSCH 950b. The preamble 950a may correspond to a first four-step RACH message (e.g., the msg1 612 of FIG. 6A) or may correspond to a preamble of the first two-step RACH message (e.g., the preamble 662a of the msgA 662 of FIG. 6B). The PUSCH 950b may correspond to a PUSCH of the first two-step RACH message (e.g., the payload 662b of the msgA 662 of FIG. 6B) or a third four-step RACH message (e.g., the msg3 616 of FIG. 6A).

The UE 904 may employ preamble-based reporting of the SSB group report 932 or may employ PUSCH-based reporting of the SSB group report 932. In examples in which the UE 904 employs preamble-based reporting, the UE 904 may indicate the group index for the selected SSB subset via a RACH occasion or a preamble partitioning associated with the preamble 950a. For example, the RACH occasions may include sets of time-frequency resources that map to respective SSB subsets. Similarly, different preambles may map to respective SSB subsets. For example, and with respect to the first SSB grouping 1000 and the third SSB grouping 1040 of FIG. 10, a first RACH occasion or a first preamble may map to the first subset 1002 of the first SSB grouping 1000, a second RACH occasion or a second preamble may map to the second subset 1004 of the first SSB grouping 1000, . . . , a fifth RACH occasion or a fifth preamble may map to the first subset 1042 of the third SSB grouping 1040, and a sixth RACH occasion or a sixth preamble may map to the second subset 1044 of the third SSB grouping 1040. Thus, based on the preamble 950a, the UE 904 may indicate the selected SSB subset and the base station 902 may determine SSB subset of the SSB group report 932.

In examples in which the UE 904 employs PUSCH-based reporting of the SSB group report 932, the UE 904 may include a standalone reporting of the SSB group report 932 of the PUSCH of the reporting message 950. For example, the UE 904 may include the group index component 932a, the beam ordering component 932b, and/or the measurements component 932c in the PUSCH 950b.

In some examples, the UE 904 may jointly use the preamble 950a and the PUSCH 950b of the reporting message 950 to transmit the SSB group report 932. For example, the UE 904 may include the group index in the preamble 950a and include the beam ordering and/or measurements in the PUSCH 950b. In examples in which the UE 904 jointly uses the preamble 950a and the PUSCH 950b to report the SSB group report 932, the UE 904 may use a RACH occasion and/or a preamble to indicate the group index, as described above in connection with the preamble-based reporting.

As shown in FIG. 9, in a first aspect, the preamble 950a may be configured to include the group index component 932a and the PUSCH 950b may be configured to include the beam ordering component 932b and/or the measurements component 932c of the SSB group report 932. In a second aspect, the 950a may be an unmodified preamble and the PUSCH 950b may be configured to include the group index component 932a, the beam ordering component 932b, and/or the measurements component 932c of the SSB group report 932.

The base station 902 may determine, at 952, a beam to indicate to the UE 904 to use for further communication with the UE 904. Aspects of determining the beam to indicate to the UE 904 (e.g., at 952) may be similar to determining the alternate beam for downlink communication (e.g., at 830 of FIG. 8). For example, the base station 902 may apply signal processing techniques, AI techniques, and/or ML techniques to determine the beam to indicate.

In some examples, the determined beam may be the same as the TX beam used by the UE 904 to transmit the reporting message 950. For example, the determined beam may correspond to the designated SSB or the TX beam selected by the UE 904 (e.g., selected at 940). In some examples, the determined beam may correspond to a beam that was reported on by the UE 904 via the SSB group report 932, but that is different than the TX beam used by the UE 904 to transmit the reporting message 950. For example, the UE 904 may use the SSB6 of the third subset 1006 to transmit the reporting message 950, but the determined beam may correspond to the SSB2 of the third subset 1006. In some examples, the SSB index 956 may correspond to a beam different than a beam reported on by the UE 904. For example, the base station 902 may determine to use the SSB5 of the second subset 1004 for downlink communication.

As shown in FIG. 9, the base station 902 may transmit a response message 954 that is received by the UE 904. The UE 904 may use the selected RX beam (e.g., selected at 940) to receive the response message 954. The response message 954 may correspond to the second message of the four-step RACH procedure (e.g., the msg2 614 of FIG. 6A) or may correspond to the second message of the two-step RACH procedure (e.g., the msgB 664 of FIG. 6B). In some examples, the response message 954 may correspond to a RAR-UL grant MAC-PDU.

In the example of FIG. 9, the response message 954 includes an SSB index 956. The SSB index 956 may correspond to the beam determined by the base station 902 for downlink communication (e.g., at 952).

As shown in FIG. 9, the UE 904 may transmit a reverting message 958 that is received by the base station 902. The reverting message 958 may include an SSB report 960 associated with an SSB beam that is different than the beam indicated by the SSB index 956. Aspects of the SSB report 960 may be similar to the SSB report 814 of FIG. 8. For example, the SSB report 960 may include an SSB index associated with a beam and measurement information (e.g., an RSRP and/or an SINR) for the associated beam.

In examples in which the UE 904 transmits the reverting message 958 including the SSB report 960, the UE 904 may operate as if the base station 902 will use the beam indicated by the SSB report 960 for subsequent downlink transmissions to the UE 904. That is, the UE 904 may assume that there is downlink/uplink quasi-co-location (QCL) for subsequent downlink messages with the beam indicated by the SSB report 960.

In some examples, when the UE 904 transmits the reverting message 958 including the SSB report 960, the beam indicated by the SSB report 960 may be selected from a previously reported on beam. In some examples, limiting the beam indicated by the SSB report 960 to a previously reported on beam may reduce blind detection at the base station 902.

In the above description of FIG. 9, the UE 904 provides reporting on a single SSB subset (e.g., the third subset 1006 of the first SSB grouping 1000). However, in other examples, the UE 904 may provide reporting on multiple SSB subsets. For example, the UE 904 may be located between the SSB5 and the SSB6 of the SSB burst set 916 and may want to report on an SSB subset that includes the SSB5 and the SSB subset that includes the SSB6. In such examples, the UE 904 may select, at 914, a first SSB subset that includes the SSB5 and a second SSB subset that includes the SSB6. In some examples, the selected SSB subsets may be part of the same grouping option. For example, the first SSB subset may correspond to the second subset 1004 of the first SSB grouping 1000 and the second SSB subset may correspond to the third subset 1006 of the first SSB grouping 1000. In other examples, the selected SSB subsets may be selected from different SSB groupings. For example, the first SSB subset may correspond to the second subset 1004 of the first SSB grouping 1000 and the second SSB subset may correspond to the first subset 1042 of the third SSB grouping 1040.

The UE 904 may also perform measurements, at 920, for the selected SSB subsets, and may also generate, at 930, an SSB group report based on the measurements for the multiple SSB subsets. In examples in which the UE 904 provides reporting for multiple SSB subsets, the multiple SSB subsets may include a primary SSB subset and one or more secondary SSB subsets. The primary SSB subset may correspond to the SSB subset having the beam with the strongest signal strength. The one or more secondary SSB subsets may be ordered based on their respective strongest beams. For example, the strongest beam of a first secondary SSB subset may be weaker than the strongest beam of the primary SSB subset and stronger than any other beams within the other remaining SSB subsets, the strongest beam of a second secondary SSB subset may be weaker than the strongest beam of the first secondary SSB subset and stronger than any other beams within the other remaining SSB subsets, etc.

In the illustrated example of FIG. 9, the UE 904 may generate (e.g., at 930) an SSB group report 970 that provides reporting for multiple SSB subsets (e.g., a primary SSB subset and a secondary SSB subset). For example, the SSB group report 970 provides reporting for a primary SSB subset 980 (e.g., the third subset 1006 of the first SSB grouping 1000) and a secondary SSB subset 982 (e.g., the second subset 1004 of the first SSB grouping 1000). In the example of FIG. 9, the primary SSB subset 980 and the secondary SSB subset 982 are different SSB subsets of a same SSB grouping (e.g., the example first SSB grouping 1000 of FIG. 10). However, in other examples, the primary SSB subset and the secondary SSB subset may be included in different SSB groupings (e.g., the first SSB grouping 1000, the second SSB grouping 1020, and/or the third SSB grouping 1040). Additionally, while the example of FIG. 9 includes reporting for a single secondary SSB subset (e.g., the secondary SSB subset 982), in other examples, the SSB group report 970 may include any suitable quantity of secondary SSB subsets that may be selected from one or more grouping options.

Similar to the SSB group report 932, the SSB group report 970 may include a group index component 972, a beam ordering component 974, and/or a measurements component 976 for each of the multiple SSB subsets. For example, the SSB group report 970 includes a primary group index 972a, a primary beam ordering 974a, and primary measurements 976a associated with the primary SSB subset 980. In the example of FIG. 9, the primary SSB subset 980 and the SSB subset of the SSB group report 932 are the same SSB subset (e.g., the third subset 1006 of the first SSB grouping 1000) and, thus, the primary group index 972a, the primary beam ordering 974a, and the primary measurements 976a correspond to the values of the group index component 932a, the beam ordering component 932b, and the measurements component 932c of the SSB group report 932.

As shown in FIG. 9, the SSB group report 970 also includes values for the secondary SSB subset 982. For example, the SSB group report 970 includes a secondary group index 972b, a secondary beam ordering 974b, and secondary measurements 976b associated with the secondary SSB subset 982. In the example of FIG. 9, the value of the secondary group index 972b indicates the secondary SSB subset 982 (e.g., “1004”). The secondary beam ordering 974b indicates an ordering of the beams of the secondary SSB subset 982 based on beam strengths associated with each of the respective beams. For example, the first value of the secondary beam ordering 974b may correspond to the beam with the strongest beam strength (e.g., the SSB5) and the last value of the secondary beam ordering 974b may correspond to the beam with the weakest beam strength (e.g., the SSB13). As shown in FIG. 9, the secondary beam ordering 974b includes a beam ordering (e.g., “[5, 9, 1, 13]”) indicating the ordering of the beam strengths associated with the SSBs of the secondary SSB subset 982. The secondary measurements 976b indicates the measurements associated with each of the beams of the secondary SSB subset 982 and may include the measurements in the order indicated by the secondary beam ordering 974b. Similar to the values of the measurements component 932c of the SSB group report 932, the measurements of the secondary measurements 976b are indicated via codepoints, where each codepoint corresponds to a respective measurement range (e.g., a range of decibels) and a smaller codepoint corresponds to a stronger beam strength. For example, the secondary measurements 976b includes measurements (e.g., “[1, 2, 2, 7]”) associated with the secondary SSB subset 982. In the example of FIG. 9, the measurements associated with the second beam (e.g., SSB9) and the third beam (e.g., SSB1) map to the same measurement codepoint (e.g., “2”). However, the absolute measurements associated with the second beam and the third beam may be different. For example, the absolute measurements associated with the second beam and the third beam may be different signal strengths within a 20 dB range that maps to the measurement codepoint “2.” In some examples, when two or more beams associated with a same absolute measurement, the UE 904 may order the beams based on index value. For example, the UE 904 may order SSB1 before SSB9 in the secondary beam ordering 974b.

Although the example SSB group report 970 of FIG. 9 includes values for the group index component 972, the beam ordering component 974, and the measurements component 976 for the primary SSB subset 980 and the secondary SSB subset 982, in other examples, the SSB group report 970 may include different information for the primary SSB subset and the one or more secondary SSB subsets. For example, the UE 904 may reduce overhead associated with reporting the SSB group report 970 by reporting less information associated with the one or more secondary SSB subsets than reported for the primary SSB subset.

For example, with respect to the primary SSB subset 980, the SSB group report 970 may include the primary group index 972a, the primary beam ordering 974a, and the primary measurements 976a, and with respect to the secondary SSB subset 982, the SSB group report 970 may include the secondary group index 972b, and the secondary beam ordering 974b. In another example, the SSB group report 970 may include the primary group index 972a and the primary beam ordering 974a associated with the primary SSB subset 980, and may include the secondary group index 972b associated with the secondary SSB subset 982.

In some examples, the quantization resolution associated with the multiple SSB subsets may be different. For example, the primary measurements 976a may have a higher quantization granularity than the secondary measurements 976b. For example, the primary measurements 976a may map to 4-bit codepoints, while the secondary measurements 976b may map to 2-bit codepoints.

In some examples, the different SSB subsets of the SSB group report 970 may include different quantities of SSBs. In some examples, the primary SSB subset may be selected from an SSB grouping that has fewer SSBs in each SSB subset than an SSB grouping from which the one or more secondary SSB subsets may be selected. For example, the primary SSB subset may be selected from the first SSB grouping 1000 or the second SSB grouping 1020, which include four SSBs in each SSB subset, while the secondary SSB subset may be selected from the third SSB grouping 1040, which includes eight SSBs in each SSB subset. In other examples, the primary SSB subset may be selected from an SSB grouping that has more SSBs in each SSB subset than an SSB grouping from which the one or more secondary SSB subsets may be selected.

In some examples, the UE 904 may select, at 940, the TX beam and/or the RX beam based on the primary SSB subset 980. For example, the UE 904 may use the designated SSB from the primary SSB subset 980 to transmit the reporting message 950 and/or to receive the response message 954. The designated SSB may be configured by the base station 902 (e.g., via the configuration information 910). In other example, the designated SSB may be determined and reported by the UE 904 based on a RACH occasion and/or a preamble partitioning.

In some example, the UE 904 may determine the uplink/downlink QCL based on the primary SSB subset. For example, the primary SSB subset 980 may include the beam associated with the strongest signal strength of the reported beams. Thus, the UE 904 may assume that there is uplink/downlink QCL for subsequent downlink messages with the beam associated with the strongest signal strength of the reported beams (e.g., the SSB6 of the third subset 1006 and the second subset 1004).

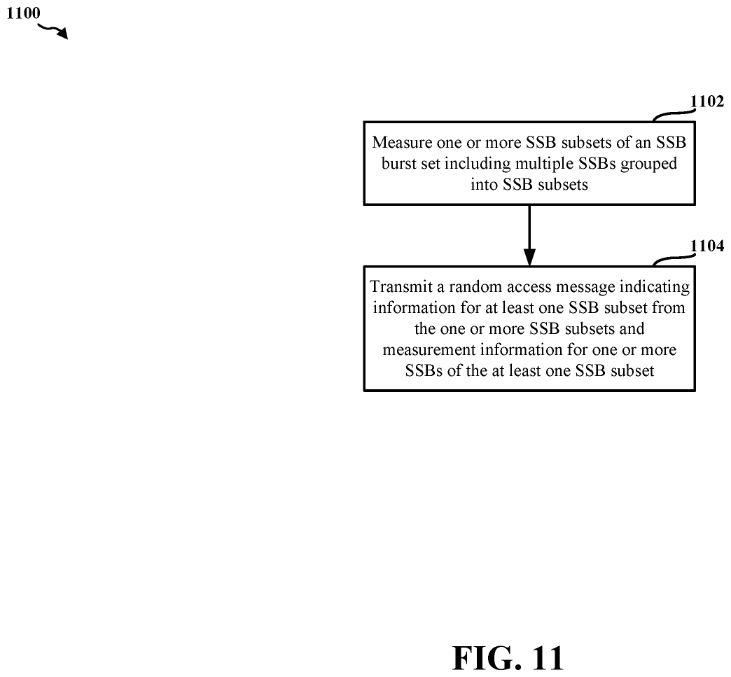

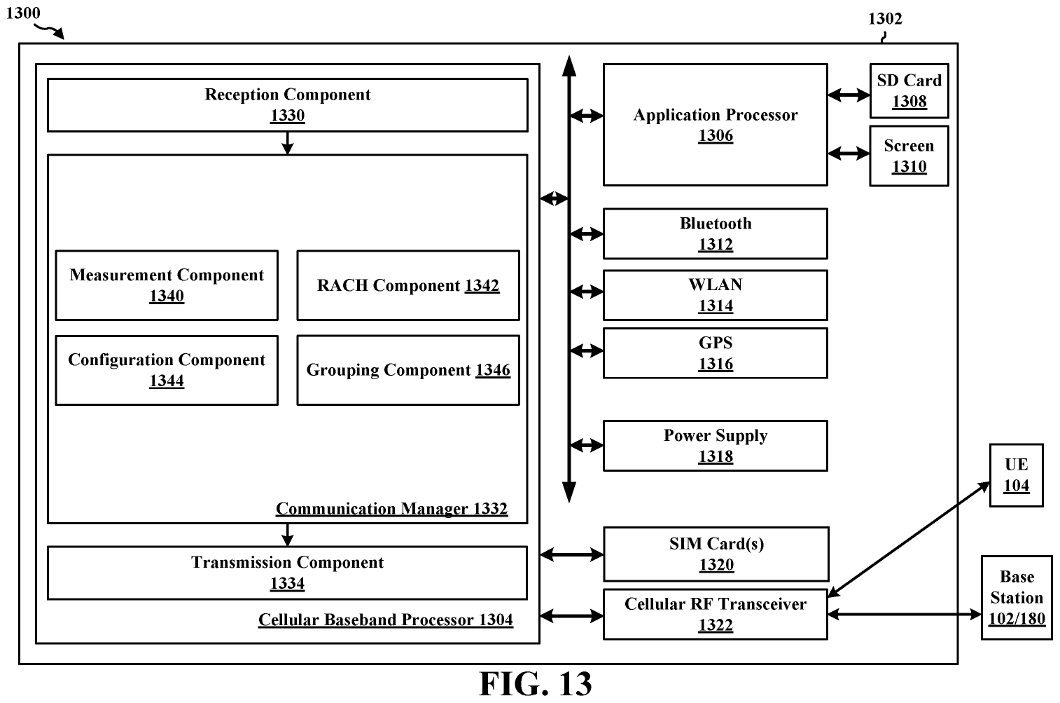

FIG. 11 is a flowchart 1100 of a method of wireless communication. The method may be performed by a UE (e.g., the UE 104, the UE 350, and/or an apparatus 1302 of FIG. 13). The method may facilitate reducing latency by enabling the UE to reduce overhead associated with reporting multiple SSBs.

At 1102 the UE measures one or more SSB subsets of an SSB burst set including multiple SSBs grouped into SSB subsets, as described in connection with 920 of FIG. 9. For example, 1102 may be performed by a measurement component 1340 of the apparatus 1302 of FIG. 13.

At 1104, the UE transmits, to a base station, a random access message indicating information for at least one SSB subset from the one or more SSB subsets and measurement information for one or more SSBs of the at least one SSB subset, as described in connection with the reporting message 950 of FIG. 9. For example, 1104 may be performed by a RACH component 1342 of the apparatus 1302 of FIG. 13.

In some examples, the random access message may further include an ordering indication indicating an ordering of the one or more SSBs within the at least one SSB subset indicated in the random access message, as described in connection with the beam ordering component 932b and/or the beam ordering component 974 of FIG. 9. The ordering of the one or more SSBs may be based in part on at least of a beam strength and a beam interference associated with each of the one or more SSBs. In some examples, the ordering indication may be based in part on indicating at least one SSB index within the at least one SSB subset associated with a strongest beam strength or the beam interference, or indicating an explicit ordering of the one or more SSBs within the at least one SSB subset.

In some examples, the measurement information may include at least one of an L1-RSRP or an SINR of the one or more SSBs within the at least one SSB subset.

In some example, the random access message may include at least one of: a Msg1 in a four-step RACH procedure, a MsgA preamble in a two-step RACH procedure, a MsgA PUSCH in the two-step RACH procedure, or an uplink message before an RRC setup. In some such examples, the measurement information may be indicated based on a RO in which the random access message is transmitted or a preamble included in the random access message. In some examples, the measurement information may be independently indicated in the MsgA PUSCH in the two-step RACH procedure. In some examples, an RO or a preamble may indicate an SSB subset index for an SSB subset, and a PUSCH may indicate at least one of an SSB ordering of the one or more SSBs of the one or more SSB subsets or a measurement associated with the one or more SSBs of the one or more SSB subsets. In some examples, the measurement may include at least one of an L1-RSRP or an SINR.

In some examples, the random access message may include the measurement information for a reduced set of SSBs within the at least one SSB subset. In some such examples, a quantity of SSBs of the reduced set of SSBs may be based on a base station configuration, such as the example selective reporting parameter 910c of FIG. 9. In some examples, the quantity of SSBs of the reduced set of SSBs may be based on a UE determination. In some example, the quantity of SSBs of the reduced set of SSBs may be based on a criteria (e.g., the strongest k SSBs).

In some examples, the random access message may indicate multiple SSB subsets within the SSB burst set and corresponding measurement information, as described in connection with the group index component 972 and/or the measurements component 976 of the SSB group report 970 of FIG. 9. In some such examples, the random access message may include different measurement information for different SSB subsets.

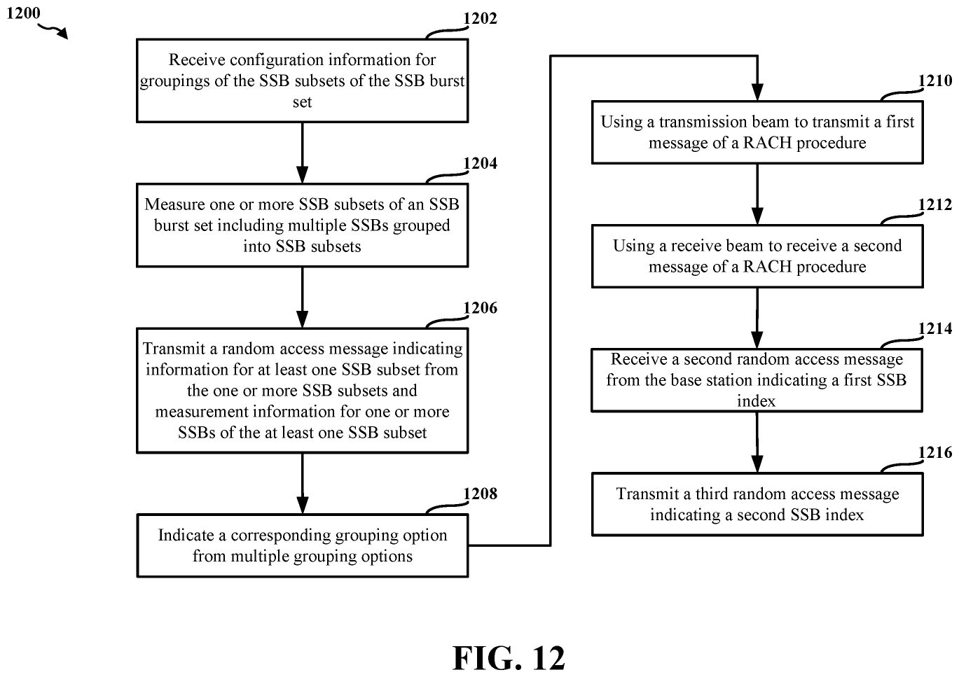

FIG. 12 is a flowchart 1200 of a method of wireless communication. The method may be performed by a UE (e.g., the UE 104, the UE 350, and/or an apparatus 1302 of FIG. 13). The method may facilitate reducing latency by enabling the UE to reduce overhead associated with reporting multiple SSBs.

At 1204 the UE measures one or more SSB subsets of an SSB burst set including multiple SSBs grouped into SSB subsets, as described in connection with 920 of FIG. 9. For example, 1204 may be performed by a measurement component 1340 of the apparatus 1302 of FIG. 13.

At 1206, the UE transmits, to a base station, a random access message indicating information for at least one SSB subset from the one or more SSB subsets and measurement information for one or more SSBs of the at least one SSB subset, as described in connection with the reporting message 950 of FIG. 9. For example, 1206 may be performed by a RACH component 1342 of the apparatus 1302 of FIG. 13.

In some examples, the random access message may further include an ordering indication indicating an ordering of the one or more SSBs within the at least one SSB subset indicated in the random access message, as described in connection with the beam ordering component 932b and/or the beam ordering component 974 of FIG. 9. The ordering of the one or more SSBs may be based in part on at least of a beam strength and a beam interference associated with each of the one or more SSBs. In some examples, the ordering indication may be based in part on indicating at least one SSB index within the at least one SSB subset associated with a strongest beam strength or the beam interference, or indicating an explicit ordering of the one or more SSBs within the at least one SSB subset.

In some examples, the measurement information may include at least one of an L1-RSRP or an SINR of the one or more SSBs within the at least one SSB subset.

In some example, the random access message may include at least one of: a Msg1 in a four-step RACH procedure, a MsgA preamble in a two-step RACH procedure, a MsgA PUSCH in the two-step RACH procedure, or an uplink message before an RRC setup. In some such examples, the measurement information may be indicated based on a RO in which the random access message is transmitted or a preamble included in the random access message. In some examples, the measurement information may be independently indicated in the MsgA PUSCH in the two-step RACH procedure. In some examples, an RO or a preamble may indicate an SSB subset index for an SSB subset, and a PUSCH may indicate at least one of an SSB ordering of the one or more SSBs of the one or more SSB subsets or a measurement associated with the one or more SSBs of the one or more SSB subsets. In some examples, the measurement may include at least one of an L1-RSRP or an SINR.

In some examples, the random access message may include the measurement information for a reduced set of SSBs within the at least one SSB subset. In some such examples, a quantity of SSBs of the reduced set of SSBs may be based on a base station configuration, such as the example selective reporting parameter 910c of FIG. 9. In some examples, the quantity of SSBs of the reduced set of SSBs may be based on a UE determination. In some example, the quantity of SSBs of the reduced set of SSBs may be based on a criteria (e.g., the strongest k SSBs).

In some examples, the random access message may indicate multiple SSB subsets within the SSB burst set and corresponding measurement information, as described in connection with the group index component 972 and/or the measurements component 976 of the SSB group report 970 of FIG. 9. In some such examples, the random access message may include different measurement information for different SSB subsets.

In some examples, at 1202, the UE may receive configuration information for groupings of the SSB subsets of the SSB burst set, as described in connection with grouping information 910b of the configuration information 910 of FIG. 9. For example, 1202 may be performed by a configuration component 1344 of the apparatus 1302 of FIG. 13. In some examples, the configuration information may be based at least in part on RACH configurations in system information or RRC configurations while operating in an RRC connected mode.

In some examples, the configuration information may include one or more of: a transmission beam direction, a transmission beam angular spread, a first transmission beam angle separation between adjacent SSBs within a corresponding SSB subset, or a second transmission beam angle separation between at least two SSBs within different SSB subsets, as described in connection with the beam information 910a of FIG. 9.

In some examples, the SSB burst set may be based on one of multiple grouping options, as described in connection with the example SSB grouping options of FIG. 10. In some such examples, the UE may, at 1208, indicate a corresponding grouping option from the multiple grouping options, as described in connection with the group index component 932a and/or the group index component 972 of FIG. 9. For example, 1208 may be performed by a grouping component 1346 of the apparatus 1302 of FIG. 13. In some examples, different options of the multiple grouping options may be associated with different quantization granularities to report at least one of an L1-RSRP or an SINR.

In some examples, each SSB subset of the SSB burst set may include a designated SSB that may be used to determine a transmission beam to transmit a first message of a RACH procedure or to determine a receive beam to receive a second message of the RACH procedure. In some examples, the first message may include a msg1 of a four-step RACH procedure or a msgA of a two-step RACH procedure, and the second message may include a msg2 of the four-step RACH procedure or a msgB of the two-step RACH procedure. In some examples, the designated SSB may be based on configuration information received from the base station, such as the example designated SSBs 1010 and/or the designated SSBs 1046 of the FIG. 10. In some example, the UE may determine the designated SSB and reported the designated SSB at least in part on a corresponding random access occasion (RO) or a corresponding preamble of the first message.

At 1210, the UE may use a transmission beam to transmit a first message of a RACH procedure, as described in connection with the reporting message 950 of FIG. 9. For example, 1210 may be performed by a transmission component 1334 of the apparatus 1302 of FIG. 13. The first message may include a msg1 of a four-step RACH procedure or a msgA of a two-step RACH procedure.

At 1212, the UE may use a receive beam to receive a second message of the RACH procedure, as described in connection with the response message 954 of FIG. 9. For example, 1212 may be performed by a reception component 1330 of the apparatus 1302 of FIG. 13. The second message may include a msg2 of the four-step RACH procedure or a msgB of the two-step RACH procedure.

In some examples, the transmission beam (e.g., at 1210) and the receive beam (e.g., at 1212) may be based on a group of SSBs within the one or more SSBs reported in the random access message.

At 1214, the UE may receive a second random access message from the base station indicating a first SSB index to the UE that is different than one or more SSB indexes associated with the at least one SSB subset reported in the first random access message, as described in connection with the SSB index 956 of FIG. 9. For example, 1214 may be performed by the RACH component 1342 of the apparatus 1302 of FIG. 13.

At 1216, the UE may transmit a third random access message to the base station indicating a second SSB index that is different than the first SSB index indicated by the base station, as described in connection with the SSB report 960 of FIG. 9. For example, 1216 may be performed by the RACH component 1342 of the apparatus 1302 of FIG. 13.

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, or a power supply 1318. The cellular baseband processor 1304 communicates through the cellular RF transceiver 1322 with the UE 104 and/or the base station 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the cellular baseband processor 1304, and in another configuration, the apparatus 1302 may be the entire UE (e.g., see the UE 350 of FIG. 3) and include the additional modules of the apparatus 1302.

The communication manager 1332 includes a measurement component 1340 that is configured to measure one or more SSB subsets of an SSB burst set including multiple SSBs grouped into SSB subsets, for example, as described in connection with 1102 of FIGS. 11 and/or 1204 of FIG. 12.

The communication manager 1332 also includes a RACH component 1342 that is configured to transmit, to a base station, a random access message indicating information for at least one SSB subset from the one or more SSB subsets and measurement information for one or more SSBs of the at least one SSB subset, for example, as described in connection with 1104 of FIGS. 11 and/or 1206 of FIG. 12. The example RACH component 1342 may also be configured to receive a second random access message from the base station indicating a first SSB index to the UE that is different than one or more SSB indexes associated with the at least one SSB subset reported in the first random access message, for example, as described in connection with 1214 of FIG. 12. The example RACH component 1342 may also be configured to transmit a third random access message to the base station indicating a second SSB index that is different than the first SSB index indicated by the base station, for example, as described in connection with 1216 of FIG. 12.

The communication manager 1332 also includes a configuration component 1344 that is configured to receive configuration information for groupings of the one or more SSB subsets of the SSB burst set, the configuration information based at least in part on RACH configurations in system information or RRC configurations while operating in an RRC connected mode, for example, as described in connection with 1202 of FIG. 12.

The communication manager 1332 also includes a grouping component 1346 that is configured to indicate, in the random access message, a corresponding grouping option from the multiple grouping options, for example, as described in connection with 1208 of FIG. 12.

In some examples, the transmission component 1334 may be configured to transmit a first message of a RACH procedure using a transmission beam, the first message including a msg1 of a four-step RACH procedure or a msgA of a two-step RACH procedure, for example, as described in connection with 1210 of FIG. 12.

In some examples, the reception component 1330 may be configured to receive a second message of the RACH procedure using a receive beam, the second message including a msg2 of the four-step RACH procedure or a msgB of the two-step RACH procedure, for example, as described in connection with 1212 of FIG. 12.

The apparatus may include additional components that perform each of the blocks of the algorithm in the flowcharts of FIGS. 11 and/or 12. As such, each block in the flowcharts of FIGS. 11 and/or 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, includes means for measuring one or more SSB subsets of an SSB burst set including multiple SSBs grouped into SSB subsets. The example apparatus 1302 also includes means for transmitting, to a base station, a random access message indicating information for at least one SSB subset from the one or more SSB subsets and measurement information for one or more SSBs of the at least one SSB subset.

In another configuration, the example apparatus 1302 also includes means for receiving configuration information for groupings of the SSB subsets of the SSB burst set, the configuration information based at least in part on RACH configurations in system information or RRC configurations while operating in an RRC connected mode.

In another configuration, the example apparatus 1302 also includes means for indicating, in the random access message, a corresponding grouping option from the multiple grouping options.

In another configuration, the example apparatus 1302 also includes means for using a transmission beam to transmit a first message of a RACH procedure, the first message including a msg1 of a four-step RACH procedure or a msgA of a two-step RACH procedure, or using a receive beam to receive a second message of the RACH procedure, the second message including a msg2 of the four-step RACH procedure or a msgB of the two-step RACH procedure, wherein the transmission beam and the receive beam are based on a group of SSBs within the one or more SSBs reported in the random access message.

In another configuration, the example apparatus 1302 also includes means for receiving a second random access message from the base station indicating a first SSB index to the UE that is different than one or more SSB indexes associated with the at least one SSB subset reported in the first random access message.

In another configuration, the example apparatus 1302 also includes means for transmitting a third random access message to the base station indicating a second SSB index that is different than the first SSB index indicated by the base station.

The means may be one or more of the components of the apparatus 1302 configured to perform the functions recited by the means. As described supra, the apparatus 1302 may include the TX processor 368, the RX processor 356, and the controller/processor 359. As such, in one configuration, the means may be the TX processor 368, the RX processor 356, and the controller/processor 359 configured to perform the functions recited by the means.

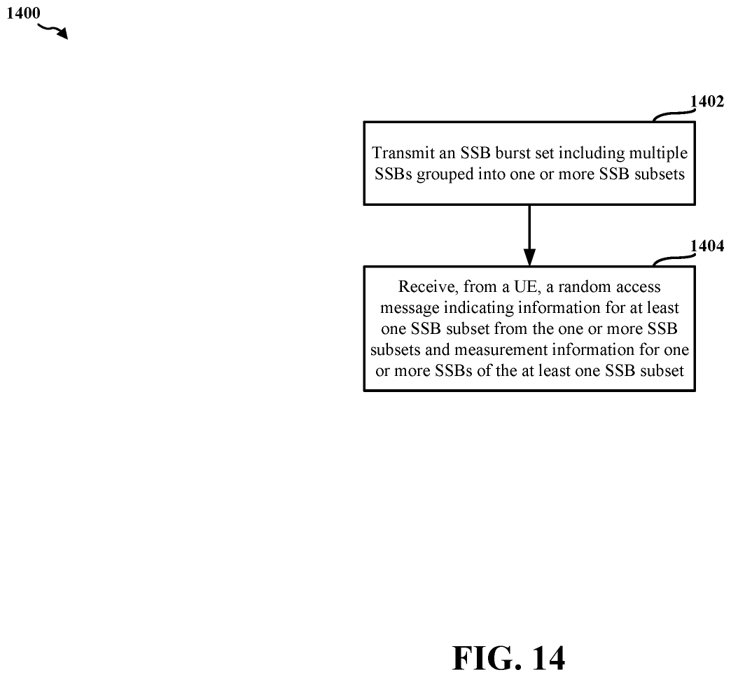

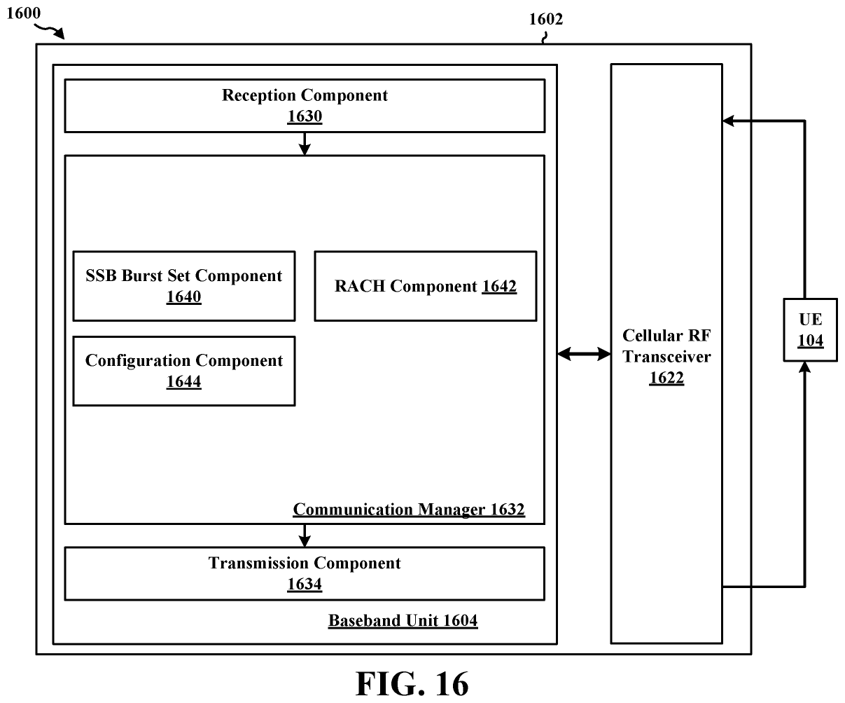

FIG. 14 is a flowchart 1400 of a method of wireless communication. The method may be performed by a base station (e.g., the base station 102/180, the base station 310, and/or an apparatus 1602 of FIG. 16). The method may facilitate reducing latency by enabling the UE to reduce overhead associated with reporting multiple SSBs.

At 1402, the base station transmits an SSB burst set including multiple SSBs grouped into one or more SSB subsets, as described in connection with the SSB burst set 916 of FIG. 9. For example, 1402 may be performed by an SSB burst set component 1640 of the apparatus 1602 of FIG. 16.

In some examples, the SSB burst set may be based on one of multiple grouping options, as described in connection with the example SSB grouping options of FIG. 10. In some such examples, the random access message may indicate a corresponding grouping option from the multiple grouping options, as described in connection with the group index component 932a and/or the group index component 972 of FIG. 9. In some examples, different options of the multiple grouping options may be associated with different quantization granularities to report at least one of an L1-RSRP or an SINR.

At 1404, the base station receives, from a UE, a random access message indicating information for at least one SSB subset from the one or more SSB subsets and measurement information for one or more SSBs of the at least one SSB subset, as described in connection with the reporting message 950 of FIG. 9. For example, 1404 may be performed by a RACH component 1642 of the apparatus 1602 of FIG. 16.

In some examples, the random access message may further include an ordering indication indicating an ordering of the one or more SSBs within the at least one SSB subset indicated in the random access message, as described in connection with the beam ordering component 932b and/or the beam ordering component 974 of FIG. 9. The ordering of the one or more SSBs may be based in part on at least of a beam strength and a beam interference associated with each of the one or more SSBs. In some examples, the ordering indication may be based in part on indicating at least one SSB index within the at least one SSB subset associated with a strongest beam strength or the beam interference, or indicating an explicit ordering of the one or more SSBs within the at least one SSB subset.

In some examples, the measurement information may include at least one of an L1-RSRP or an SINR of the one or more SSBs within the at least one SSB subset.

In some example, the random access message may include at least one of: a Msg1 in a four-step RACH procedure, a MsgA preamble in a two-step RACH procedure, a MsgA PUSCH in the two-step RACH procedure, or an uplink message before an RRC setup. In some such examples, the measurement information may be indicated based on a RO in which the random access message is transmitted or a preamble included in the random access message. In some examples, the measurement information may be independently indicated in the MsgA PUSCH in the two-step RACH procedure. In some examples, an RO or a preamble may indicate an SSB subset index for an SSB subset, and a PUSCH may indicate at least one of an SSB ordering of the one or more SSBs of the one or more SSB subsets or a measurement associated with the one or more SSBs of the one or more SSB subsets. In some examples, the measurement may include at least one of an L1-RSRP or an SINR.

In some examples, the random access message may include the measurement information for a reduced set of SSBs within the at least one SSB subset. In some such examples, a quantity of SSBs of the reduced set of SSBs may be based on a base station configuration, such as the example selective reporting parameter 910c of FIG. 9. In some examples, the quantity of SSBs of the reduced set of SSBs may be based on a UE determination. In some example, the quantity of SSBs of the reduced set of SSBs may be based on a criteria (e.g., the strongest k SSBs).

In some examples, the random access message may indicate multiple SSB subsets within the SSB burst set and corresponding measurement information, as described in connection with the group index component 972 and/or the measurements component 976 of the SSB group report 970 of FIG. 9. In some such examples, the random access message may include different measurement information for different SSB subsets.

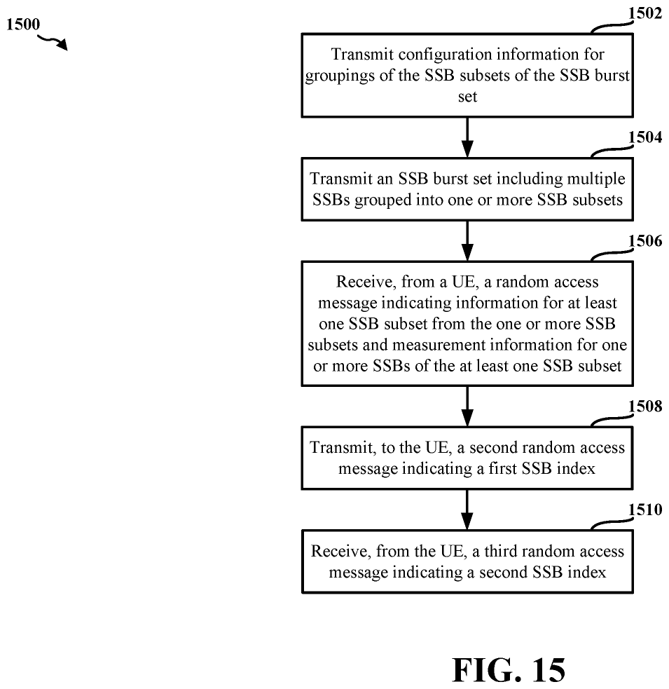

FIG. 15 is a flowchart 1500 of a method of wireless communication. The method may be performed by a base station (e.g., the base station 102/180, the base station 310, and/or an apparatus 1602 of FIG. 16). The method may facilitate reducing latency by enabling the UE to reduce overhead associated with reporting multiple SSBs.

At 1504, the base station transmits an SSB burst set including multiple SSBs grouped into one or more SSB subsets, as described in connection with the SSB burst set 916 of FIG. 9. For example, 1504 may be performed by an SSB burst set component 1640 of the apparatus 1602 of FIG. 16.

In some examples, the SSB burst set may be based on one of multiple grouping options, as described in connection with the example SSB grouping options of FIG. 10. In some such examples, the random access message may indicate a corresponding grouping option from the multiple grouping options, as described in connection with the group index component 932a and/or the group index component 972 of FIG. 9. In some examples, different options of the multiple grouping options may be associated with different quantization granularities to report at least one of an L1-RSRP or an SINR.

At 1506, the base station receives, from a UE, a random access message indicating information for at least one SSB subset from the one or more SSB subsets and measurement information for one or more SSBs of the at least one SSB subset, as described in connection with the reporting message 950 of FIG. 9. For example, 1506 may be performed by a RACH component 1642 of the apparatus 1602 of FIG. 16.

In some examples, the random access message may further include an ordering indication indicating an ordering of the one or more SSBs within the at least one SSB subset indicated in the random access message, as described in connection with the beam ordering component 932b and/or the beam ordering component 974 of FIG. 9. The ordering of the one or more SSBs may be based in part on at least of a beam strength and a beam interference associated with each of the one or more SSBs. In some examples, the ordering indication may be based in part on indicating at least one SSB index within the at least one SSB subset associated with a strongest beam strength or the beam interference, or indicating an explicit ordering of the one or more SSBs within the at least one SSB subset.

In some examples, the measurement information may include at least one of an L1-RSRP or an SINR of the one or more SSBs within the at least one SSB subset.

In some example, the random access message may include at least one of: a Msg1 in a four-step RACH procedure, a MsgA preamble in a two-step RACH procedure, a MsgA PUSCH in the two-step RACH procedure, or an uplink message before an RRC setup. In some such examples, the measurement information may be indicated based on a RO in which the random access message is transmitted or a preamble included in the random access message. In some examples, the measurement information may be independently indicated in the MsgA PUSCH in the two-step RACH procedure. In some examples, an RO or a preamble may indicate an SSB subset index for an SSB subset, and a PUSCH may indicate at least one of an SSB ordering of the one or more SSBs of the one or more SSB subsets or a measurement associated with the one or more SSBs of the one or more SSB subsets. In some examples, the measurement may include at least one of an L1-RSRP or an SINR.

In some examples, the random access message may include the measurement information for a reduced set of SSBs within the at least one SSB subset. In some such examples, a quantity of SSBs of the reduced set of SSBs may be based on a base station configuration, such as the example selective reporting parameter 910c of FIG. 9. In some examples, the quantity of SSBs of the reduced set of SSBs may be based on a UE determination. In some example, the quantity of SSBs of the reduced set of SSBs may be based on a criteria (e.g., the strongest k SSBs).

In some examples, the random access message may indicate multiple SSB subsets within the SSB burst set and corresponding measurement information, as described in connection with the group index component 972 and/or the measurements component 976 of the SSB group report 970 of FIG. 9. In some such examples, the random access message may include different measurement information for different SSB subsets.

In some examples, at 1502, the base station may transmit configuration information for groupings of the SSB subsets of the SSB burst set, as described in connection with the grouping information 910b of the configuration information 910 of FIG. 9. For example, 1502 may be performed by a configuration component 1644 of the apparatus 1602 of FIG. 16. In some examples, the configuration information may be based at least in part on RACH configurations in system information or RRC configurations while operating in an RRC connected mode.

In some examples, the configuration information may include one or more of: a transmission beam direction, a transmission beam angular spread, a first transmission beam angle separation between adjacent SSBs within a corresponding SSB subset, or a second transmission beam angle separation between at least two SSBs within different SSB subsets, as described in connection with the beam information 910a of FIG. 9

In some examples, each SSB subset of the SSB burst set may include a designated SSB that may be used by the UE to determine a transmission beam to transmit a first message of a RACH procedure or to determine a receive beam to receive a second message of the RACH procedure. In some examples, the first message may include a msg1 of a four-step RACH procedure or a msgA of a two-step RACH procedure, and the second message may include a msg2 of the four-step RACH procedure or a msgB of the two-step RACH procedure. In some examples, the designated SSB may be based on configuration information transmitted by the base station, such as the example designated SSBs 1010 and/or the designated SSBs 1046 of the FIG. 10. In some example, the designated SSB may be reported at least in part on a corresponding RO or a corresponding preamble of the first message.

At 1508, the base station may transmit, to the UE, a second random access message indicating a first SSB index to the UE that is different than one or more SSB indexes associated with the at least one SSB subset reported in the first random access message, as described in connection with the SSB index 956 of FIG. 9. For example, 1508 may be performed by the RACH component 1642 of the apparatus 1602 of FIG. 16.

At 1510, the base station may receive a third random access message from the UE indicating a second SSB index that is different than the second SSB index indicated by the base station, as described in connection with the SSB report 960 of FIG. 9. For example, 1216 may be performed by the RACH component 1342 of the apparatus 1302 of FIG. 13.

FIG. 16 is a diagram 1600 illustrating an example of a hardware implementation for an apparatus 1602. The apparatus 1602 may be a base station, a component of a base station, or may implement base station functionality. In some aspects, the apparatus 1602 may include a baseband unit 1604. The baseband unit 1604 may communicate through a cellular RF transceiver 1622 with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the base station 310 and may include the memory 376 and/or at least one of the TX processor 316, the RX processor 370, and the controller/processor 375.

The communication manager 1632 includes an SSB burst set component 1640 that is configured to transmit an SSB burst set including multiple SSBs grouped into one or more SSB subsets, for example, as described in connection with 1402 of FIGS. 14 and/or 1504 of FIG. 15.

The communication manager 1632 also includes a RACH component 1642 that is configured to receive, from a UE, a random access message indicating information for at least one SSB subset from the one or more SSB subsets and measurement information for one or more SSBs of the at least one SSB subset, for example, as described in connection with 1404 of FIGS. 14 and/or 1506 of FIG. 15. The example RACH component 1642 may also be configured to transmit, to the UE, a second random access message indicating a first SSB index, for example, as described in connection with 1508 of FIG. 15. The example RACH component 1642 may also be configured to receive, from the UE, a third random access message indicating a second SSB index, for example, as described in connection with 1510 of FIG. 15.

The communication manager 1632 also includes a configuration component 1644 that is configured to transmit configuration information for groupings of the SSB subsets of the SSB burst set, for example, as described in connection with 1502 of FIG. 15.

The apparatus may include additional components that perform each of the blocks of the algorithm in the flowcharts of FIGS. 14 and/or 15. As such, each block in the flowcharts of FIGS. 14 and/or 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the baseband unit 1604, includes means for transmitting a SSB burst set including multiple SSBs grouped into one or more SSB subsets. The example apparatus 1602 also includes means for receiving, from a UE, a random access message indicating information for at least one SSB subset from the one or more SSB subsets and measurement information for one or more SSBs of the at least one SSB subset.

In another configuration, the example apparatus 1602 also includes means for transmitting configuration information for groupings of the one or more SSB subsets of the SSB burst set, the configuration information based at least in part on RACH configurations in system information or RRC configurations while operating in an RRC connected mode.

In another configuration, the example apparatus 1602 also includes means for using a receive beam to receive a first message of a RACH procedure, the first message including a msg1 of a four-step RACH procedure or a msgA of a two-step RACH procedure, or using a transmission beam to transmit a second message of the RACH procedure, the second message including a msg2 of the four-step RACH procedure or a msgB of the two-step RACH procedure, wherein the transmission beam and the receive beam are based on a group of SSBs within the one or more SSBs reported in the random access message

In another configuration, the example apparatus 1602 also includes means for transmitting a second random access message to the UE, the second random access message indicating a first SSB index to the UE that is different than one or more SSB indexes associated with the at least one SSB subset reported in the first random access message.

In another configuration, the example apparatus 1602 also includes means for receiving a third random access message from the UE, the third random access message indicating a second SSB index that is different than the first SSB index indicated by the base station.

The means may be one or more of the components of the apparatus 1602 configured to perform the functions recited by the means. As described supra, the apparatus 1602 may include the TX processor 316, the RX processor 370, and the controller/processor 375. As such, in one configuration, the means may be the TX processor 316, the RX processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is an apparatus for wireless communication at a UE including at least one processor coupled to a memory, the memory and the at least one processor configured to: measure one or more SSB subsets of an SSB burst set including multiple SSBs grouped into SSB subsets; and transmit, to a base station, a random access message indicating information for at least one SSB subset from the one or more SSB subsets and measurement information for one or more SSBs of the at least one SSB subset.

Aspect 2 is the apparatus of aspect 1, further including that the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on: indicating at least one SSB index within the at least one SSB subset associated with a strongest beam strength or the beam interference, or indicating an explicit ordering of the one or more SSBs within the at least one SSB subset.

Aspect 3 is the apparatus of any of aspects 1 and 2, further including that the measurement information includes at least one of an L1-RSRP or an SINR of the one or more SSBs within the at least one SSB subset.

Aspect 4 is the apparatus of any of aspects 1 to 3, further including that the memory and the at least one processor are further configured to: receive configuration information for groupings of the one or more SSB subsets of the SSB burst set, the configuration information based at least in part on RACH configurations in system information or RRC configurations while operating in an RRC connected mode, wherein the apparatus further comprises a transceiver coupled to the at least one processor.

Aspect 5 is the apparatus of any of aspects 1 to 4, further including that the configuration information includes one or more of: a transmission beam direction, a transmission beam angular spread, a first transmission beam angle separation between adjacent SSBs within a corresponding SSB subset, or a second transmission beam angle separation between at least two SSBs within different SSB subsets.

Aspect 6 is the apparatus of any of aspects 1 to 5, further including that the SSB burst set is based on one of multiple grouping options, the memory and the at least one processor are further configured to: indicate, in the random access message, a corresponding grouping option from the multiple grouping options.

Aspect 7 is the apparatus of any of aspects 1 to 6, further including that different options of the multiple grouping options are associated with different quantization granularities to report at least one of an L1-RSRP or an SINR.

Aspect 8 is the apparatus of any of aspects 1 to 7, further including that the random access message includes at least one of: a Msg1 in a four-step RACH procedure, a MsgA preamble in a two-step RACH procedure, a MsgA PUSCH in the two-step RACH procedure, or an uplink message before an RRC setup.

Aspect 9 is the apparatus of any of aspects 1 to 8, further including that the measurement information is indicated based on a random access occasion (RO) in which the random access message is transmitted or a preamble included in the random access message.

Aspect 10 is the apparatus of any of aspects 1 to 9, further including that the measurement information is independently indicated in the MsgA PUSCH in the two-step RACH procedure.

Aspect 11 is the apparatus of any of aspects 1 to 10, further including that a random access occasion (RO) or preamble indicates an SSB subset index for an SSB subset, and a PUSCH indicates at least one of an SSB ordering of the one or more SSBs of the one or more SSB subsets or a measurement associated with the one or more SSBs of the one or more SSB subsets, the measurement including at least one of an L1-RSRP or an SINR.

Aspect 12 is the apparatus of any of aspects 1 to 11, further including that the random access message includes the measurement information for a reduced set of SSBs within the at least one SSB subset, wherein a quantity of SSBs of the reduced set of SSBs is based on at least one of: a base station configuration, a UE determination, or a criteria.

Aspect 13 is the apparatus of any of aspects 1 to 12, further including that each SSB subset of the SSB burst set includes a designated SSB, the designated SSB used to determine a transmission beam to transmit a first message of a RACH procedure or to determine a receive beam to receive a second message of the RACH procedure, the first message including a message 1 (msg1) of a four-step RACH procedure or a message A (msgA) of a two-step RACH procedure, the second message including a message 2 (msg2) of the four-step RACH procedure or a message B (msgB) of the two-step RACH procedure, the designated SSB based on at least one of: configuration information received from the base station, or a UE determination reported at least in part on a corresponding random access occasion (RO) or a corresponding preamble of the first message.

Aspect 14 is the apparatus of any of aspects 1 to 13, further including that the memory and the at least one processor are further configured to: use a transmission beam to transmit a first message of a RACH procedure, the first message including a message 1 (msg1) of a four-step RACH procedure or a message A (msgA) of a two-step RACH procedure, or use a receive beam to receive a second message of the RACH procedure, the second message including a message 2 (msg2) of the four-step RACH procedure or a message B (msgB) of the two-step RACH procedure, wherein the transmission beam and the receive beam are based on a group of SSBs within the one or more SSBs reported in the random access message.

Aspect 15 is the apparatus of any of aspects 1 to 14, further including that the random access message includes a first random access message, the memory and the at least one processor are further configured to: receive a second random access message from the base station, the second random access message indicating a first SSB index to the UE that is different than one or more SSB indexes associated with the at least one SSB subset reported in the first random access message.

Aspect 16 is the apparatus of any of aspects 1 to 15, further including that the memory and the at least one processor are further configured to: transmit a third random access message to the base station, the third random access message indicating a second SSB index that is different than the first SSB index indicated by the base station.

Aspect 17 is the apparatus of any of aspects 1 to 16, further including that the random access message indicates multiple SSB subsets within the SSB burst set and corresponding measurement information.

Aspect 18 is the apparatus of any of aspects 1 to 17, further including that the random access message includes different measurement information for different SSB subsets.

In aspect 19, the apparatus of aspect 1 further includes at least one antenna coupled to the at least one processor.

In aspect 20, the apparatus of aspect 1 or 19 further includes a transceiver coupled to the at least one processor.

Aspect 21 is a method of wireless communication for implementing any of aspects 1 to 18.

Aspect 22 is an apparatus for wireless communication including means for implementing any of aspects 1 to 18.

In aspect 23, the apparatus of aspect 22 further includes at least one antenna coupled to the means to perform any of aspects 1 to 18.

In aspect 24, the apparatus of aspect 22 or 23 further includes a transceiver coupled to the means to perform any of aspects 1 to 18.

Aspect 25 is a non-transitory computer-readable storage medium storing computer executable code, where the code, when executed, causes a processor to implement any of aspects 1 to 18.

Aspect 26 is an apparatus for wireless communication at a network node including at least one processor coupled to a memory, the memory and the at least one processor configured to: transmit a SSB burst set including multiple SSBs grouped into one or more SSB subsets; and receive a random access message indicating information for at least one SSB subset from the one or more SSB subsets and measurement information for one or more SSBs of the at least one SSB subset.

Aspect 27 is the apparatus of aspect 26, further including that the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on: indicating at least one SSB index within the at least one SSB subset associated with a strongest beam strength or the beam interference, or indicating an explicit ordering of the one or more SSBs within the at least one SSB subset.

Aspect 28 is the apparatus of any of aspects 26 and 27, further including that the measurement information includes at least one of an L1-RSRP or an SINR of the one or more SSBs within the at least one SSB subset.

Aspect 29 is the apparatus of any of aspects 26 to 28, further including that the memory and the at least one processor are further configured to: transmit configuration information for groupings of the one or more SSB subsets of the SSB burst set, the configuration information based at least in part on RACH configurations in system information or RRC configurations while operating in an RRC connected mode.

Aspect 30 is the apparatus of any of aspects 26 to 29, further including that the configuration information includes one or more of: a transmission beam direction, a transmission beam angular spread, a first transmission beam angle separation between adjacent SSBs within a corresponding SSB subset, or a second transmission beam angle separation between at least two SSBs within different SSB subsets.

Aspect 31 is the apparatus of any of aspects 26 to 30, further including that the SSB burst set is based on one of multiple grouping options.

Aspect 32 is the apparatus of any of aspects 26 to 31, further including that different options of the multiple grouping options are associated with different quantization granularities to report at least one of an L1-RSRP or an SINR.

Aspect 33 is the apparatus of any of aspects 26 to 32, further including that the random access message includes at least one of: a Msg1 in a four-step RACH procedure, a MsgA preamble in a two-step RACH procedure, a MsgA PUSCH in the two-step RACH procedure, or an uplink message before an RRC setup.

Aspect 34 is the apparatus of any of aspects 26 to 33, further including that the measurement information is indicated based on an RO in which the random access message is received or a preamble included in the random access message.

Aspect 35 is the apparatus of any of aspects 26 to 34, further including that the measurement information is independently indicated in the MsgA PUSCH in the two-step RACH procedure.

Aspect 36 is the apparatus of any of aspects 26 to 35, further including that an RO or preamble indicates an SSB subset index for an SSB subset, and a PUSCH indicates at least one of an SSB ordering of the one or more SSBs of the one or more SSB subsets or a measurement associated with the one or more SSBs of the one or more SSB subsets, the measurement including at least one of an L1-RSRP or an SINR.

Aspect 37 is the apparatus of any of aspects 26 to 36, further including that the random access message includes the measurement information for a reduced set of SSBs within the at least one SSB subset, wherein a quantity of SSBs of the reduced set of SSBs is based on at least one of: a configuration, a UE determination, or a criteria.

Aspect 38 is the apparatus of any of aspects 26 to 37, further including that each SSB subset of the SSB burst set includes a designated SSB, the designated SSB used to determine a receive beam to receive a first message of a RACH procedure or to determine a transmit beam to transmit a second message of the RACH procedure, the first message including a msg1 of a four-step RACH procedure or a msgA of a two-step RACH procedure, the second message including a msg2 of the four-step RACH procedure or a msgB of the two-step RACH procedure, the designated SSB based on at least one of: configuration information transmitted to a UE, or a UE determination reported at least in part on a corresponding RO or a corresponding preamble of the first message.

Aspect 39 is the apparatus of any of aspects 26 to 38, further including that the memory and the at least one processor are further configured to: use a receive beam to receive a first message of a RACH procedure, the first message including a msg1 of a four-step RACH procedure or a msgA of a two-step RACH procedure, or use a transmission beam to transmit a second message of the RACH procedure, the second message including a msg2 of the four-step RACH procedure or a msgB of the two-step RACH procedure, wherein the transmission beam and the receive beam are based on a group of SSBs within the one or more SSBs reported in the random access message.

Aspect 40 is the apparatus of any of aspects 26 to 39, further including that the random access message includes a first random access message, the memory and the at least one processor are further configured to: transmit a second random access message to a UE, the second random access message indicating a first SSB index to the UE that is different than one or more SSB indexes associated with the at least one SSB subset reported in the first random access message.

Aspect 41 is the apparatus of any of aspects 26 to 40, further including that the memory and the at least one processor are further configured to: receive a third random access message from a UE, the third random access message indicating a second SSB index that is different than the first SSB index indicated by the network node.

Aspect 42 is the apparatus of any of aspects 26 to 41, further including that the random access message indicates multiple SSB subsets within the SSB burst set and corresponding measurement information.

Aspect 43 is the apparatus of any of aspects 26 to 42, further including that the random access message includes different measurement information for different SSB subsets.

In aspect 44, the apparatus of aspect 26 further includes at least one antenna coupled to the at least one processor.

In aspect 45, the apparatus of aspect 26 or 44 further includes a transceiver coupled to the at least one processor.

Aspect 46 is a method of wireless communication for implementing any of aspects 26 to 43.

Aspect 47 is an apparatus for wireless communication including means for implementing any of aspects 26 to 43.

In aspect 48, the apparatus of aspect 47 further includes at least one antenna coupled to the means to perform any of aspects 26 to 43.

In aspect 49, the apparatus of aspect 47 or 48 further includes a transceiver coupled to the means to perform any of aspects 26 to 43.

Aspect 50 is a non-transitory computer-readable storage medium storing computer executable code, where the code, when executed, causes a processor to implement any of aspects 26 to 43.

What is claimed is:

1. An apparatus for wireless communication at a user equipment (UE), comprising:
a memory; and
at least one processor coupled to the memory, the memory and the at least one processor configured to:
measure one or more synchronization signal block (SSB) subsets of an SSB burst set including multiple SSBs grouped into SSB subsets; and
transmit, to a base station, a random access message indicating information for at least one SSB subset from the one or more SSB subsets and measurement information for one or more SSBs of the at least one SSB subset.

2. The apparatus of claim 1, wherein the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on:
indicating at least one SSB index within the at least one SSB subset associated with a strongest beam strength or the beam interference, or
indicating an explicit ordering of the one or more SSBs within the at least one SSB subset.

3. The apparatus of claim 1, wherein the measurement information includes at least one of a layer 1 reference signal receive power (L1-RSRP) or a signal to interference and noise ratio (SINR) of the one or more SSBs within the at least one SSB subset.

4. The apparatus of claim 1, wherein the memory and the at least one processor are further configured to:
receive configuration information for groupings of the one or more SSB subsets of the SSB burst set, the configuration information based at least in part on random access channel (RACH) configurations in system information or radio resource control (RRC) configurations while operating in an RRC connected mode,
wherein the apparatus further comprises a transceiver coupled to the at least one processor.

5. The apparatus of claim 4, wherein the configuration information includes one or more of:
a transmission beam direction,
a transmission beam angular spread,
a first transmission beam angle separation between adjacent SSBs within a corresponding SSB subset, or
a second transmission beam angle separation between at least two SSBs within different SSB subsets.

6. The apparatus of claim 1, wherein the SSB burst set is based on one of multiple grouping options, the memory and the at least one processor are further configured to:
indicate, in the random access message, a corresponding grouping option from the multiple grouping options.

7. The apparatus of claim 6, wherein different options of the multiple grouping options are associated with different quantization granularities to report at least one of a layer 1 reference signal receive power (L1-RSRP) or a signal to interference and noise ratio (SINR).

8. The apparatus of claim 1, wherein the random access message includes at least one of:
a Msg1 in a four-step random access channel (RACH) procedure,
a MsgA preamble in a two-step RACH procedure,
a MsgA physical uplink shared channel (PUSCH) in the two-step RACH procedure, or
an uplink message before a radio resource control (RRC) setup.

9. The apparatus of claim 8, wherein the measurement information is indicated based on a random access occasion (RO) in which the random access message is transmitted or a preamble included in the random access message.

10. The apparatus of claim 8, wherein the measurement information is independently indicated in the MsgA PUSCH in the two-step RACH procedure.

11. The apparatus of claim 8, wherein a random access occasion (RO) or preamble indicates an SSB subset index for an SSB subset, and a PUSCH indicates at least one of an SSB ordering of the one or more SSBs of the one or more SSB subsets or a measurement associated with the one or more SSBs of the one or more SSB subsets, the measurement including at least one of a layer 1 reference signal receive power (L1-RSRP) or a signal to interference and noise ratio (SINR).

12. The apparatus of claim 1, wherein the random access message includes the measurement information for a reduced set of SSBs within the at least one SSB subset, wherein a quantity of SSBs of the reduced set of SSBs is based on at least one of:
a base station configuration,
a UE determination, or
a criteria.

13. The apparatus of claim 1, wherein each SSB subset of the SSB burst set includes a designated SSB, the designated SSB used to determine a transmission beam to transmit a first message of a random access channel (RACH) procedure or to determine a receive beam to receive a second message of the RACH procedure, the first message including a message 1 (msg1) of a four-step RACH procedure or a message A (msgA) of a two-step RACH procedure, the second message including a message 2 (msg2) of the four-step RACH procedure or a message B (msgB) of the two-step RACH procedure, the designated SSB based on at least one of:
configuration information received from the base station, or
a UE determination reported at least in part on a corresponding random access occasion (RO) or a corresponding preamble of the first message.

14. The apparatus of claim 1, wherein the memory and the at least one processor are further configured to:
use a transmission beam to transmit a first message of a random access channel (RACH) procedure, the first message including a message 1 (msg1) of a four-step RACH procedure or a message A (msgA) of a two-step RACH procedure, or
use a receive beam to receive a second message of the RACH procedure, the second message including a message 2 (msg2) of the four-step RACH procedure or a message B (msgB) of the two-step RACH procedure,
wherein the transmission beam and the receive beam are based on a group of SSBs within the one or more SSBs reported in the random access message.

15. The apparatus of claim 14, wherein the random access message includes a first random access message, the memory and the at least one processor are further configured to:
receive a second random access message from the base station, the second random access message indicating a first SSB index to the UE that is different than one or more SSB indexes associated with the at least one SSB subset reported in the first random access message.

16. The apparatus of claim 15, wherein the memory and the at least one processor are further configured to:
transmit a third random access message to the base station, the third random access message indicating a second SSB index that is different than the first SSB index indicated by the base station.

17. The apparatus of claim 1, wherein the random access message indicates multiple SSB subsets within the SSB burst set and corresponding measurement information.

18. The apparatus of claim 17, wherein the random access message includes different measurement information for different SSB subsets.

19. A method of wireless communication at a user equipment (UE), comprising:
measuring one or more synchronization signal block (SSB) subsets of an SSB burst set including multiple SSBs grouped into SSB subsets; and
transmitting, to a base station, a random access message indicating information for at least one SSB subset from the one or more SSB subsets and measurement information for one or more SSBs of the at least one SSB subset.

20. The method of claim 19, wherein the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on:
indicating at least one SSB index within the at least one SSB subset associated with a strongest beam strength or the beam interference, or
indicating an explicit ordering of the one or more SSBs within the at least one SSB subset.

21. The method of claim 19, further including:
receiving configuration information for groupings of the one or more SSB subsets of the SSB burst set, the configuration information based at least in part on random access channel (RACH) configurations in system information or radio resource control (RRC) configurations while operating in an RRC connected mode.

22. The method of claim 19, wherein the SSB burst set is based on one of multiple grouping options, the method further including:
indicating, in the random access message, a corresponding grouping option from the multiple grouping options.

23. The method of claim 19, further including:
using a transmission beam to transmit a first message of a random access channel (RACH) procedure, the first message including a message 1 (msg1) of a four-step RACH procedure or a message A (msgA) of a two-step RACH procedure, or
using a receive beam to receive a second message of the RACH procedure, the second message including a message 2 (msg2) of the four-step RACH procedure or a message B (msgB) of the two-step RACH procedure,
wherein the transmission beam and the receive beam are based on a group of SSBs within the one or more SSBs reported in the random access message.

24. The method of claim 23, wherein the random access message includes a first random access message, the method further including:
receiving a second random access message from the base station, the second random access message indicating a first SSB index to the UE that is different than one or more SSB indexes associated with the at least one SSB subset reported in the first random access message.

25. The method of claim 24, further including:
transmitting a third random access message to the base station, the third random access message indicating a second SSB index that is different than the first SSB index indicated by the base station.

26. An apparatus for wireless communication at a network node, comprising:
a memory; and
at least one processor coupled to the memory, the memory and the at least one processor configured to:
transmit a synchronization signal block (SSB) burst set including multiple SSBs grouped into one or more SSB subsets; and
receive a random access message indicating information for at least one SSB subset from the one or more SSB subsets and measurement information for one or more SSBs of the at least one SSB subset.

27. The apparatus of claim 26, wherein the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on:
indicating at least one SSB index within the at least one SSB subset associated with a strongest beam strength or the beam interference, or
indicating an explicit ordering of the one or more SSBs within the at least one SSB subset.

28. The apparatus of claim 26, wherein the measurement information includes at least one of a layer 1 reference signal receive power (L1-RSRP) or a signal to interference and noise ratio (SINR) of the one or more SSBs within the at least one SSB subset.

29. A method of wireless communication at a network node, comprising:
transmitting a synchronization signal block (SSB) burst set including multiple SSBs grouped into one or more SSB subsets; and
receiving a random access message indicating information for at least one SSB subset from the one or more SSB subsets and measurement information for one or more SSBs of the at least one SSB subset.

30. The method of claim 29, wherein the random access message further includes an ordering indication indicating an ordering of the one or more SSBs within the at least one SSB subset indicated in the random access message, the ordering of the one or more SSBs based in part on at least of a beam strength and a beam interference associated with each of the one or more SSBs, the ordering indication based in part on:
indicating at least one SSB index within the at least one SSB subset associated with a strongest beam strength or the beam interference, or
indicating an explicit ordering of the one or more SSBs within the at least one SSB subset.
